(19) United States
(12) Patent Application Publication
(10) Pub. No.: US 2011/0300270 A1
(43) Pub. Date: Dec. 8, 2011

(54) COOKING DEVICE AND METHOD OF MEAL PREPARATION

(76) Inventor: Paul Anthony Koppens, Remuera (NZ)

(21) Appl. No.: 13/147,047

(22) PCT Filed: Feb. 2, 2010
(86) PCT No.: PCT/NZ2010/000010

§ 371 Date: Aug. 29, 2011

(30) Foreign Application Priority Data
Feb. 2, 2009 (NZ) 574632

(51) Int. Cl. A47J 27/00; B67D 7/00; A23L 1/01

(52) U.S. Cl. 426/115; 99/352; 426/231; 222/129

(57) ABSTRACT

A pre-loadable cartridge for retaining and dispensing of ingredients of a meal to be subsequently cooked, the cartridge including an ingredient separating portion of at least two compartments, one for solid ingredient and one for liquid ingredient. Also includes is a base portion that together with the ingredient separating portion defines a receptacle for retaining said ingredients in each compartment. The ingredient separating portion and base portion are moveable relative to each other. Each compartment includes a first aperture, and the base portion includes at least one second aperture, such that in use, the ingredient separating portion is able to be moved relative to the base portion to allow the first aperture of each compartment to be moved into operable communication with at least one second aperture to provide an outlet passage for ingredient in each compartment from the cartridge through the base portion.

### FIELD OF THE INVENTION

The present invention relates to a cooking device, and more particularly, though not solely, to a method of meal preparation.

### BACKGROUND TO THE INVENTION

It is useful to provide an improved or alternative cooking device Likewise, improved or alternative methods of meal preparation are useful.

In particular, devices which help simplify cooking procedures for meal preparation can be useful. Such devices and improved meal preparation methods may be preferred by some consumers who lack sufficient time to prepare a meal wholly themselves or by more traditional methods. Additionally, such devices may allow more readily for consumers to have a meal cooked for them in an efficient manner that may also provide a meal cooked in a style that the consumer is unable to perform themselves. For example, some people are unable to cook a stir-fry meal in a manner that reasonably replicates the authenticity of a meal cooked by specialist or trained stir-fry food chef.

In another example, it may be desirable to provide a cooking device or meal preparation methods suitable for those people who do not wish to or are not able to cook a stir-fry meal themselves due to time constraints on them.

It would therefore be advantageous to provide a device capable of cooking food, for example in the stir-fry style.

It is therefore an object of the present invention to provide a cooking device and/or a method of meal preparation which will go at least some way towards addressing the foregoing problems or which will at least provide the public with a useful choice.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

Further aspects and advantages of the present invention will become apparent from the ensuing description which is given by way of example only.

### SUMMARY OF THE INVENTION

In a first aspect the present invention may be said to be a pre-loadable cartridge for retaining and dispensing of ingredients of a meal or at least a part of a meal to be dispensed from the cartridge for subsequent combination with each other, the cartridge comprising:
an ingredient separating portion of at least two compartments, a first of said compartments to retain primarily solid ingredient and a second compartment to retain primarily liquid ingredient and
a base portion that together with the ingredient separating portion defines a receptacle for retaining said ingredients in each compartment,
the ingredient separating portion and base portion being moveable relative to each other,
wherein each compartment includes a first aperture, and the base portion includes at least one second aperture, such that in use, the ingredient separating portion is able to be moved relative to the base portion to allow the first aperture of each compartment to be moved into operable communication with at least one second aperture to provide an outlet passage for ingredient in each compartment from the cartridge through the base portion.

Preferably each first aperture and said at least one second aperture become communicable with each other by their alignment to define said outlet passage to dispense ingredients into an awaiting vessel at a preferred or predetermined time during a cooking program.

Preferably for each first aperture the base portion provides a respective second aperture so that liquid ingredient will pass through a first of said second apertures and solid ingredient will pass through a second of said second apertures.

Preferably the ingredient separating portion and base portion are separable. Preferably the base portion and the ingredient separating portion are injection moulded from a food grade polymeric material.

Preferably the base portion is sealingly engageable with the ingredient retaining portion in a manner to effect a sealing of the first aperture of each compartment to facilitate retaining of ingredient located therein.

Preferably
(a) the first aperture of the first compartment communicable with a second aperture of the base portion (hereinafter a “first base portion aperture”) providing for an outlet passage from the first compartment when in aligned communication, the first aperture of the first compartment and the first base potion aperture alignable by movement of the ingredient separating portion and base portion relative to one another and
(b) wherein the first aperture of the second compartment is communicable with a second aperture of the base portion (hereinafter a “second base portion aperture”) providing for an outlet passage from the second compartment when in aligned communication, the first aperture of the second compartment and the second base portion aperture alignable by movement of the ingredient separating portion and base portion relative to one another.

Preferably the base portion and the ingredient retaining portion are fittingly engageable with each other in a manner to form a seal between the base and the two compartments about their first aperture, when fitted together.

Preferably at least one of the base portion and ingredient retaining portion carries with it a layer provided to form said seal.

Preferably the layer is selected from at least one of (a) at least one o-ring and (b) at least one sleeve.

Preferably a said second aperture is a section of the base portion being a void space, such a void space defining an outlet passage to allow contents of at least one compartment to dispense therefrom when the first aperture is in communication, the apertures becoming communicable and non communicable by movement of the ingredient retaining portion relative to the base portion.

Preferably the outlet passage formed by communication of the second apertures allows for release of ingredient otherwise retained within a said compartment when the first aperture is not aligned with a said second aperture.

Preferably the ingredient retaining portion is moveable relative to the base portion according to a cooking program sequence, the cartridge having been loaded with ingredients before being subjected to said cooking program sequence.

In a second aspect the present invention may be said to be pre-loaded cartridge for retaining and dispensing of pre-loaded ingredients of a meal or at least a part of a meal by a programmable device that can receive the cartridge and control the dispensing of said ingredients, the cartridge comprising a first part comprising two compartments that are partitioned from one another by at least one wall and
a second part of a base portion that together with the at least one compartment define a receptacle for retaining ingredients,
the first and second parts being engageable with one another and being moveable relative to each other,
wherein a first of said compartments includes at least a one first compartment aperture and the second part includes a second part aperture, such that in use, the first compartment aperture is able to become communicable with the second part aperture such communication providing for an outlet passage for ingredients in said first compartment, and
wherein a second of said compartments includes at least one second compartment aperture, such that in use, the second compartment aperture is able to become communicable with at least one of (i) the second part aperture and (ii) a second second part aperture, such communication providing for an outlet passage for ingredients in said second compartment, the apertures becoming communicable by virtue of movement of the first part relative to the second part.

In a further aspect the present invention may be said to be a cartridge for retaining and dispensing of preloaded ingredients of a meal or at least a part of a meal, the cartridge comprising:
at least two compartments segregated from one another by dividers, and
a base portion to the compartments to, together, define two receptacles, and
wherein the compartments and the base portion are engageable with one another yet are moveable relative to each other to form a liquid-tight seal therebetween for at least one of said two receptacles.

Preferably at least one of the base portion and each said compartment carries with it a layer provided to form said seal.

In a further aspect the present invention may be said to be a cooking device for cooking a meal or a part of a meal, the device comprising:
a receiver for a vessel including a cooking surface,
a heat source for heating of the cooking surface,
an arm or blade configured to move about the cooking surface for the moving of meal ingredients located thereon or within the vessel, and
a dispenser system in communication with the vessel, the dispenser system configured for receiving a cartridge as herein described and containing liquid and solid meal ingredients to be dispensed from said cartridge into the vessel for cooking at preferred or predetermined times during a cooking program.

Preferably the dispenser system is programmable or automated for dispensing of meal ingredients into the vessel according to a preferred or pre-determined cooking program.

Preferably the dispenser system comprises a loading zone for receiving said pre loaded cartridge.

In yet a further aspect the present invention may be said to be a cooking device for cooking a meal or a part of a meal, the device comprising:
a receiver for a cooking vessel, such a cooking vessel including a cooking surface,
a heat source for heating of the cooking surface,
an arm or blade configured to move about the cooking surface for the moving of meal ingredients located thereon or within the vessel, and
a dispenser system in communication with the vessel, the dispenser system configured for receiving a cartridge as herein described and containing meal ingredients to be dispensed into the vessel for cooking at preferred or predetermined times during a cooking program.

In even a further aspect the present invention may be said to be a cooking device for cooking a meal or a part of a meal, the device comprising:
a receiver for a cooking vessel, such a cooking vessel including a cooking surface,
a heat source for heating of the cooking surface, an arm or blade configured to move about the cooking surface for the moving of meal ingredients located thereon or within the vessel, and
a dispenser system in communication with the vessel, the dispenser system configured for receiving a cartridge as herein described and containing meal ingredients to be dispensed into the vessel for cooking at preferred or predetermined times during a cooking program.

In yet a further aspect the present invention may be said to be a cooking device for cooking a meal or a part of a meal, the device comprising:
a vessel including a cooking surface,
a heat source for heating of the cooking surface,
an arm or blade configured to move about the cooking surface for the moving of meal ingredients located thereon or within the vessel, and
a dispenser system in communication with the vessel, the dispenser system configured for receiving a cartridge as herein described and containing meal ingredients to be dispensed into the vessel for cooking at preferred or predetermined times during a cooking program.
In even a further aspect the present invention may be said to be a method for preparing a meal or a part of a meal, the method comprising:
selecting meal ingredients, the ingredients selected to form the or a part of a meal,
arranging or having the selected meal ingredients arranged in a cartridge as herein above described,
the cartridge being receivable by a dispensing system communicable with a cooking device,
the dispensing system programmable or automated for dispensing of the selected meal ingredients according to a preferred or pre-determined cooking program, the cooking program initiating or being initiated when the cooking device is operated or activated.

In still a further aspect the present invention may be said to be a method preparing a meal or a part of a meal, the method comprising:
a consumer selecting from an available list of meal ingredients, the ingredients selected to form the or a part of a meal,
the consumer selected meal ingredients provided in an arranged manner in a cartridge as herein above described the cartridge being compartmentalised, meal ingredients compartmentalised by food type or preferred cooking time or both,
placing the cartridge into a dispensing system communicable with a cooking device, the dispensing system programmable or automated for dispensing of meal ingredients according to a preferred or pre-determined cooking program, and
activating the cooking device to cook the meal ingredients according to the preferred or pre-determined cooking program.

In even a further aspect the present invention may be said to be a method for preparing a meal or a part of a meal, the method comprising:
a consumer selecting from an available list of meal ingredients, the ingredients selected to form the or a part of a meal,
the consumer selected meal ingredients provided in an arranged manner in a cartridge as herein described the cartridge being compartmentalised, meal ingredients compartmentalised by food type or preferred cooking time or both,
placing the cartridge into a dispensing system communicable with a cooking device, the dispensing system programmable or automated for dispensing of meal ingredients according to a preferred or pre-determined cooking program, and
activating the cooking device to cook the meal ingredients according to the preferred or pre-determined cooking program.

In even a further aspect the present invention may be said to be a method for preparing a meal or a part of a meal, the method comprising:
a consumer selecting from an available list of meal options or part of a meal options comprising meal ingredients,
the meal options or the part of the meal options available are pre-arranged in a cartridge as herein described,
placing the cartridge into a dispensing system communicable with a cooking device, the dispensing system programmable or automated for dispensing of meal ingredients according to a preferred or pre-determined cooking program, and
activating the cooking device to cook the meal ingredients according to the preferred or pre-determined cooking program.

Also described herein is a cartridge for retaining and dispensing of ingredients of a meal or at least a part of a meal, the cartridge comprising: at least one compartment (preferably, the compartments are partitioned from one another by dividers or walls) and a base portion that together with the at least one compartment define a receptacle for retaining ingredients, the compartments and base portion being engageable with one another and being moveable relative to each other,

wherein at least one of the compartments includes at least a first aperture, and the base portion includes at least a second aperture, such that in use, the first aperture of the compartments is communicable (preferably alignable) with the second aperture providing for an outlet passage from the compartment through the base portion (preferably to an awaiting vessel), the first and second apertures communicable (preferably alignable) by movement of the compartments and base portion relative to each other (preferably being aligned with one another at a preferred or predetermined time during a cooking program).

Preferably the cartridge includes at least two compartments.

Preferably the compartments and base portion are separable, for example separable for cleaning purposes.

Preferably the compartments and base portion forming the cartridge, or the formed cartridge, are stackable atop one another, preferably are at least partly nestable.

Preferably one or more parts (e.g. the compartments or base portion) for forming the cartridge are injection moulded or injection mouldable.

Preferably one or more parts (e.g. the compartments or base portion) for forming the cartridge are formed from food grade polymeric material.

Preferably the divider(s) is/are a wall or walls for partitioning the cartridge into a series of compartments.

Preferably at least one compartment is configured for retaining of solid ingredients and at least one compartment is configured to facilitate retaining of liquid ingredient.

Preferably the base portion provides a floor to one or more of the compartments to facilitate retaining of solid ingredient located therein.

Preferably the base portion is sealingly engageable (preferably as a floor) with one or more of the compartments to facilitate retaining of liquid ingredient located therein.

Preferably the base portion provides a liquid-tight seal (preferably as a floor) with or to one or more of the compartments to facilitate retaining of liquid ingredient located therein.

Preferably in a first position the base portion blocks or closes an outlet passage from one or more of the compartments retaining of solid and/or liquid ingredient located therein into the vessel.

Preferably in a second position the base portion opens or allows for an outlet passage from one or more of the compartments retaining of solid and/or liquid ingredient located therein into the vessel.

Preferably at least one of a first compartment is provided and at least one of a second compartment is provided.

Preferably the or each first compartment includes a first aperture (hereinafter a “first compartment aperture”) to allow ingredient to pass therethrough.

Preferably wherein the or each second compartment includes a first aperture (hereinafter a “second compartment aperture”) to allow ingredient to pass therethrough.

Preferably the first compartment aperture is communicable with a second aperture of the base portion (hereinafter a “first base portion aperture”) providing for an outlet passage from the first compartment when in aligned communication, the apertures alignable by movement of the compartments and base portion relative to one another.

Preferably the second compartment aperture is communicable with a second aperture of the base portion (hereinafter a “second base portion aperture”) providing for an outlet passage from the second compartment when in aligned communication, the apertures alignable by movement of the compartments and base portion relative to one another.

Preferably the first aperture is located at the floor or base of a compartment.

Preferably the first aperture is located in a side wall of a compartment.

Preferably one or more of the compartments is configured for directing ingredient(s) retained therein toward the first aperture.

Preferably the one or more of the compartments configured for directing ingredients includes an internal wall or walls sloping toward the first aperture.

Preferably the sloping wall or walls of the one or more compartments provide a drainage pathway for directing ingredients retained in the compartments toward the first aperture.

Preferably the base portion provides for a floor to one or more of the compartments. Preferably the base portion and one or more compartments are fittingly engageable with each other and/or form a seal (preferably via an interference between the base portion and the one or more compartments, forming a seal) between the base and one or more of the compartments when fitted together.

Preferably the base portion and one or more compartments are configured for abutting when assembled as the cartridge.

Preferably the base portion and one or more compartments are engageable with each other in a snap-lock manner.

Preferably a sleeve (or sleeves) or other layer (or layers) is/are positioned intermediate of the base portion and one or more of the compartments, the sleeve(s) or other layer(s) providing for sealing engagement between the base and one or more of the compartments.

Preferably the seal(s) or other layer(s) is/are a valve (or valves) or o-ring(s).

Preferably the seal(s) or other layer(s) allow for communication of a compartment's first aperture (or first apertures) and second aperture (or second apertures).

Preferably the sleeve or other layer is an elasticised or deformable material, for example a silicone rubber material, for sealing engagement between the base and one or more of the compartments.

Preferably at least one or a second of the second apertures is a section of base portion being a void space, such a void space defining an outlet passage to allow contents of the compartment to dispense therefrom when the first aperture is in communication, the apertures communicable (preferably alignable) by movement of the compartments relative to the base portion.

Preferably the outlet passage formed by communication of at least the second of the second apertures (the base portion's void space) allows for release of ingredient(s) otherwise retained within the compartment when the first and second of the second apertures are non-aligned.

Preferably a driver is engageable with the cartridge for actuating movement of the compartments and base portion relative to one another.

Preferably the driver is engageable with the cartridge via a connector (preferably the cartridge including a channel for receiving the driver or a connector of the driver).

Preferably the connector is a bar engageable with a channel of the cartridge, the bar locating the cartridge.

Preferably the compartments are moveable relative to the base portion, or the base portion is static while the compartments are moveable about the base portion.

Preferably the one or more compartments form a circular part and are rotatable about the base portion, preferably the base portion also being a circular part.

Preferably the compartments are moveable relative to the base portion according to a cooking program sequence.

Preferably meal ingredients retained within the compartments are released or able to exit or be dispensed when a compartment's first aperture is aligned with a or the second aperture.

Preferably the one or more compartments is/are integral or unitary with one another.

Preferably the one or more compartments is a first integral or unitary part.

Preferably the base portion is an integral or unitary part.

Preferably base portion is a second integral or unitary part.

Preferably the cartridge is a compartmentalised drawer.

Also described herein is a cartridge for retaining and dispensing of ingredients of a meal or at least a part of a meal, the cartridge comprising: at least one compartment (preferably, the compartments are partitioned from one another by dividers or walls) and a base portion that together with the at least one compartment define a receptacle for retaining ingredients, the compartments and base portion being engageable (preferably forming a liquid-tight seal) with one another and being moveable relative to each other, wherein at least one of the compartments includes at least a first aperture and the base portion includes at least a second aperture, such that in use, the first aperture of a or the one or more compartments is communicable (preferably alignable) with the second aperture of the base portion, such communication (preferably alignment) providing for an outlet passage (preferably a liquid outlet passage) from at least one of the first aperture including compartments, and wherein at least one or a second of the second apertures is a section of base portion being a void space, such a void space defining an outlet passage to allow contents of the compartment to dispense therefrom when the first aperture is in communication, the apertures communicable (preferably alignable) by movement of the compartments relative to the base portion (preferably being aligned with one another at a preferred or predetermined time during a cooking program).

Also described herein is a cartridge for retaining and dispensing of ingredients of a meal or at least a part of a meal, the cartridge comprising: a first part of at least one compartment (preferably, the compartments are partitioned from one another by dividers or walls) and a second part of a base portion that together with the at least one compartment define a receptacle for retaining ingredients,

the first and second parts being engageable (preferably forming a liquid-tight seal) with one another and being moveable relative to each other, wherein at least one of the compartments includes at least a first aperture and the second part includes at least a second aperture, such that in use, the first aperture of a or one of the compartments is communicable (preferably alignable) with the second aperture of the second part, such communication (preferably alignment) providing for an outlet passage (preferably a liquid outlet passage) from the one or more first aperture including compartments, and

wherein at least one or a second of the second apertures is a section of the second part being a void space, such a void space defining an outlet passage to allow contents of the compartment to dispense therefrom when the first aperture is in communication, the apertures communicable (preferably alignable) by movement of the compartments relative to the base portion (preferably being aligned with one another at a preferred or predetermined time during a cooking program).

Also described herein is a cartridge for retaining and dispensing of ingredients of a meal or at least a part of a meal, the cartridge comprising:

an enclosure with a compartment or compartments for receiving meal ingredients, (preferably) a lid covering the compartment(s), and a base portion for supporting contents of the compartment(s), wherein the base portion is removable or moveable relative to the compartment(s) or the enclosure, or the compartment(s) is/are moveable relative to the enclosure or the base portion, or the enclosure is moveable relative to the base portion, such that, in use, contents of one or more of the compartments may exit or be dispensed from the cartridge at a preferred or predetermined time during a cooking program.

Also described herein is a cartridge for retaining and dispensing of ingredients of a meal or at least a part of a meal, the cartridge comprising:

a first part and a second part, the first part being a substantially hollow enclosure with a base portion, the base sealing the entirety of the bottom of the enclosure apart from a segment and a central void, the central void in communication with a central void space extending substantially centrally upwards of the base, the enclosure and central void space communicable by a central void space opening, and the second part being a substantially hollow enclosure receivable within the first enclosure, one or more compartments formed within the second part's enclosure, wherein one or more of the compartments comprise of a compartment opening in a compartment wall, the opening alignable with the opening of the first part.

Preferably the cartridge has two or more compartments, the compartments being of the same or a different volume.

Preferably the dispenser system comprises a driver engageable for actuating the cartridge such that the selected meal ingredients are dispensed from the cartridge to the vessel according to the cooking program.

Preferably the driver actuates the cartridge such that the cartridge compartments or the base are moveable relative to the enclosure (or the enclosure is moveable relative to the compartments or base) allowing selected meal ingredients to exit or be dispensed from the cartridge.

Preferably one or more compartments of the cartridge are base portion-less.

Preferably the base portion provides a base for some, but not all, cartridge compartments.

Preferably the base portion is moveable or removeable to expose a compartment.

Preferably the cartridge is circular and a driver engages, or engageable with, the compartments, such that, actuation of the driver moves the cartridge compartments relative to the enclosure, selected meal ingredients able to exit or be dispensed from the cartridge when the meal ingredients reach a base-less compartment.

Preferably the cartridge is circular and a driver engages, or engageable with, the base portion, such that, actuation of the driver moves the base portion relative to the compartments, selected meal ingredients able to exit or be dispensed from the cartridge when base portion is removed from supporting the meal ingredient contents of a compartment.

Preferably the cartridge is square or rectilinear and a driver engages, or is engageable with, the compartments or the base portion or the enclosure being moveable relative to at least one each other, such that, actuation of the driver moves one or more compartments into a position where the base portion is non-supporting of meal ingredient contents of the compartment(s), the meal ingredients contained within such one or more compartments able to exit or be dispensed from the cartridge.

Preferably the central void space of the first part extends below the base portion.

Preferably the central void space extending below the base portion is a tubular extension.

Preferably the second part fits or engages within the first part's enclosure.

Preferably the fit or engagement of the second part within the first part's enclosure is in a sealingly engageable or abutting manner.

Preferably the central void spaces sealingly engage or are abutting with one another.

Preferably a sleeve surrounds the central void space of the first part, the sleeve forming a seal with the central void space of the second part when the first and second part are engaged with one another.

Preferably the sleeve is an elasticised or deformable material.

Preferably a liquid-tight seal is formed between the central void spaces when the first and second parts are engaged with one another.

Preferably a seal or seals is/are positioned between the central void spaces of the first and second parts.

Preferably the seal(s) are valve(s) or an o-ring(s).

Preferably the seal(s) allow for communication of a compartment opening and the opening of the first part's central void space.

Preferably the second part is moveable relative the first part.

Preferably the first part is static, the second part being moveable for dispensing of meal ingredients from the cartridge compartments.

Preferably the first and second parts are hollow shallow cylinder shaped.

Preferably first and second parts fittingly engage with one another.

Preferably the compartments are formed by a series of arms radially extending outwards from the or a exterior portion of the central void space of the second compartment.

Preferably the radial arms extend out from the central void space to an outer circular ring wall that fits within the enclosure of the first part.

Preferably one or more inner compartments are positioned adjacent the first part's central void space.

Preferably the one or more inner compartments are formed by the radial arms adjacent the central void space.

Preferably the inner compartments are liquid meal ingredient compartments.

Preferably the inner compartments comprise a floor portion, the floor portion for retaining a liquid ingredient within the compartment.

Preferably the floor portion is sloped downwardly toward the central void space and/or toward the compartment opening.

Preferably the floor portion directs liquid ingredient stored within the compartment toward the compartment opening and central void space.

Preferably one or more outer compartments are formed by the radial arms separated from the inner compartments via a wall substantially concentric to the central void space or exterior portion of the central void space.

Preferably the one or more outer compartments are positioned adjacent the central void space.

Preferably the outer compartments are solid meal ingredient compartments.

Preferably the outer compartments are floor portion-less.

Preferably meal ingredients retained within the outer compartments are supported by the base portion of the first part.

Preferably rotation of the compartments allows liquid meal ingredient to be dispensed into the vessel when there is an alignment of the openings of the inner or liquid compartments and the corresponding opening of the central void space of the first part.

Preferably alignment of an inner or liquid compartment opening and opening of the central void space of the first part allows liquid to be dispensed from the compartment.

Preferably rotation of the compartments allows solid meal ingredients to be dispensed into the vessel when the outer or solid meal ingredient compartment is not supported by a base portion.

Preferably the cartridge is circular with compartments spaced radially about the cartridge.

Preferably the cartridge is square or rectilinear.

Preferably the cartridge is a compartmentalised drawer.

Also described herein is a vessel for cooking of meal ingredients, the vessel comprising: an inner cooking surface (preferably being of a substantially hemispherical configuration), and a locator stub (or stubs) extending from an outer surface of the vessel, the stub for locating of the vessel at a pre-determined position when locator stub(s) is/are received by a stub receiver of a cooking device, and wherein one end of an arm or blade is receivable or locatable by a first section (preferably a recess or a slot) of the vessel's wall, an end of the arm or blade of which is engageable with a driver for moving the arm or blade about the inner cooking surface.

Preferably the other (second) end of the arm or blade is receivable or supportable by a second section (preferably a recess or a slot) of the vessel's wall, the other end of the arm or blade engageable with a driver for moving the arm or blade about the cooking surface.

Preferably the vessel is configured for receiving meal ingredients from a meal ingredient dispenser system (preferably a dispenser system comprising of a cartridge), the dispenser system positioned above or being communicable with the vessel.

Preferably operation of the arm or blade is, at least in part, controlled by an automated cooking program.

Preferably operation of the arm or blade is, at least in part, controlled in response to the temperature of the cooking surface.

Preferably the arm or blade contacts the cooking surface or the cooking surface and the vessel's internal surface.

Preferably the arm or blade comprises a series of undulations or cut-out sections, or both, along a working surface or length.

Preferably the arm or blade is shaped or configured for encouraging of ingredients to fall inwards of the arm or blade or towards the centre of the blade during travel (preferably, the arm or blade comprises at least a section of which is conically shaped).

Preferably the arm or blade is driven via a connection (preferably a hinged connection) extending through a side of the vessel engaging with a driver.

Preferably the arm or blade is connected at one end by a linkage or articulation to a driver, the arm or blade configured to be rotated about an axis, preferably a horizontal axis.

Preferably a controller controls the driver according to a cooking programme or a predetermined sequence of movements or in response to a sensed temperature of the cooking surface.

Preferably the controller controls the speed of movement of the arm or blade about the surface, via the driver.

Preferably the driver is one of a linear motor or a stepper motor or a servo-motor.

Preferably the arm or blade is self-weighted to make contact with the cooking surface (preferably for tending rotation of the arm or blade towards the cooking surface).

Preferably one or more resiliently flexible devices force or act to impose the arm or the blade on or towards the cooking surface, for example by one or more springs attached to the arm or blade.

Preferably the sections or slots are of sufficient depth for allowing the arm or blade to be held in a contacting position with the cooking surface (preferably a first end of the arm or blade is receivable in the first section and the other end of the arm or blade is in hinged connection with a driver for moving the blade about a path of travel across the cooking surface, the other end of the arm or blade being receivable in the second section of the vessel).

Preferably one end of the arm or blade sits in a base of one of the sections or slots (preferably such an end engaging with a driver) and the other end of the arm or blade sitting above the base of the other section or slot when the arm or blade is at the lowest position of travel.

Preferably the arm or blade is unsupported by one or more of the sections or slots when at the lowest position of travel, the cooking surface supporting the arm or blade at such position of travel.

Preferably the arm or blade is a stirrer.

Preferably the vessel is hemispherical.

Preferably the vessel includes a meal dispensing spout region, preferably the spout region is a lip of the vessel's wall.

Preferably the stub (or stubs) extends from an underside of the vessel, the stub extending or positioned at an angle such that engagement with a stub receiver of a cooking device locates or positions the vessel at a preferred cooking off-set or tilt angle from vertical.

Preferably the stub is hollow.

Preferably the stub receiver provides a passage for the measurement of temperature (preferably providing an uninterrupted pathway to the vessel for measurement of vessel temperature).

Preferably the stub receiver comprises a temperature sensor for sensing temperature of the vessel's cooking surface.

Preferably the stub receiver provides a protective housing or shroud for a temperature sensor for sensing temperature of the vessel's cooking surface.

Preferably the temperature sensor is an infra-red temperature sensor or a thermocouple.

Preferably the stub (or stubs) extending from an underside of the vessel is received by a stub receiver, engagement of the stub with the stub receiver locating or positioning the vessel at a preferred cooking off-set or tilt angle from vertical.

Preferably the stub(s) and the stub receiver(s) engage each other at a first position and at a second (preferably rotated) position the arm or blade stirrer for the vessel is engageable or becomes engaged with a driver.

Preferably at the second (preferably rotated) position, the arm or blade and vessel are in an operable (preferably locked) position together.

Preferably the arm or blade is operable to substantially move meal ingredients to a meal dispensing spout region when a cooking program is complete or terminated.

Preferably the vessel is engageable with a cooking device, the cooking device comprising:

a receiver for the cooking vessel, a heat source for heating of the cooking surface, an arm or blade configured to move about the cooking surface for the moving of meal ingredients located thereon or within the vessel, and a dispenser system in communication with the vessel, the dispenser system configured for receiving a cartridge containing meal ingredients to be dispensed into the vessel for cooking at preferred or predetermined times during a cooking program.

Preferably the vessel is engageable with a cooking device, the cooking device comprising:

the vessel, a heat source for heating of the cooking surface, an arm or blade configured to move about the cooking surface for the moving of meal ingredients located thereon or within the vessel, and a dispenser system in communication with the vessel, the dispenser system configured for receiving a cartridge containing meal ingredients to be dispensed into the vessel for cooking at preferred or predetermined times during a cooking program.

Preferably the vessel is engageable with a cooking device, the cooking device comprising:

the vessel, a heat source for heating of the cooking surface, an arm or blade configured to move about the cooking surface for the moving of meal ingredients located thereon or within the vessel, and a dispenser system in communication with the vessel, the dispenser system configured for receiving of meal ingredients to be dispensed into the vessel for cooking at preferred or predetermined times during a cooking program.

Preferably the vessel is engageable with a cooking device, the cooking device comprising:

the vessel, a heat source for heating of the cooking surface, an arm or blade configured to move about the cooking surface for the moving of meal ingredients located thereon or within the vessel, and a dispenser system in communication with the vessel, the dispenser system configured for receiving and dispensing of meal ingredients to be dispensed into the vessel for cooking at preferred or predetermined times during a cooking program.

Preferably the vessel is engageable with a cooking device, the cooking device comprising:

the vessel, a heat source for heating of the cooking surface, an arm or blade configured to move about the cooking surface for the moving of meal ingredients located thereon or within the vessel, and a dispenser system in communication with the vessel, the dispenser system configured for receiving and dispensing of meal ingredients to be dispensed into the vessel for cooking at preferred or predetermined times during a cooking program, and wherein the dispenser system further administers (preferably as a spray) liquid ingredient, such as oil or water or a water-based liquid into the vessel at preferred or predetermined times during the cooking program.

Preferably the vessel is engageable with a cooking device, the cooking device comprising: the vessel, a heat source for heating of the cooking surface, and an arm or blade configured to move about the cooking surface for the moving of meal ingredients located thereon or within the vessel, wherein the vessel's wall (or walls) include a first slot for receiving and locating (and preferably supporting) a first end of the arm or blade and a second slot for receiving and locating (and preferably supporting) a second end of the arm or blade, the second end engageable with a driver for moving the arm or blade about the cooking surface.

Preferably the vessel is engageable with a cooking device, the cooking device comprising: the vessel, a heat source for heating of the cooking surface, and an arm or blade configured to move about the cooking surface for the moving of meal ingredients located thereon or within the vessel, wherein one end of the arm or blade is receivable or locatable by a first section (preferably a recess or a slot) of the vessel's wall, and the other end of the arm or blade is supported by a second section (preferably a recess or a slot) of the vessel's wall, the other end of the arm or blade engageable with a driver for moving the arm or blade about the cooking surface.

Also described herein is a vessel engageable with a cooking device, the cooking device comprising:

the vessel,

a heat source for heating of the cooking surface, and an arm or blade configured to move about the cooking surface for the moving of meal ingredients located thereon or within the vessel, wherein the cooking device further comprises of a stub receiver (or receivers) receivable of a locator stub (or stubs) extending from the vessel, the stub receiver(s) locating of the vessel at a pre-determined position when the vessel with locator stub(s) is/are received in-situ.

Preferably the vessel is removeable from the cooking device.

Preferably the vessel includes a handle or handles.

Preferably the handle or handles are heat insulated.

Preferably the handle or handles are wooden.

Preferably the vessel is a spun or stamped steel, such as a carbon steel.

Also described herein is a cooking device for cooking a meal or a part of a meal, the device comprising: a receiver for a vessel including a cooking surface, a heat source for heating of the cooking surface, an arm or blade configured to move about the cooking surface for the moving of meal ingredients located thereon or within the vessel, and a dispenser system in communication with the vessel, the dispenser system configured for receiving of meal ingredients to be dispensed into the vessel for cooking at preferred or predetermined times during a cooking program.

Preferably the heat source is an ignited fuel (such as a one or more of a fuel gas from a ring burner or a nit mesh burner or a pre-mix air and gas system), or an electrically heated element, or an induction-type heat source (when coupled with the vessel or vessel's cooking surface).

Preferably the heat source is a burner capable of (preferably rapidly) heating of the vessel's cooking surface to an operational temperature.

Preferably the heat source is controllable or adjustable for controlling or adjusting the temperature of the cooking surface.

Preferably the temperature of the cooking surface is controlled or adjusted according to a preferred or predetermined temperature during a cooking program or sequence of a cooking program.

Preferably the cooking device further comprises of a fume extraction system, the fume extraction system for extraction or removal of cooking fumes or other gases or exhaust from the heat source from or about the cooking device.

Preferably the vessel is sealed from heat source exhaust or output gasses.

Preferably the dispenser system is programmable or automated for dispensing of meal ingredients into the vessel according to a preferred or pre-determined cooking program.

Preferably the dispenser system is programmable or automated for dispensing of meal ingredients into the vessel from a cartridge according to a preferred or pre-determined cooking program.

Preferably the dispenser system comprises a loading zone for receiving a cartridge, the cartridge retaining meal ingredients to be dispensed to the vessel.

Preferably the dispenser system comprises a driver for actuating the cartridge such that meal ingredients are dispensed from the cartridge to the vessel.

Preferably the driver actuates the cartridge such that cartridge compartments or a base thereof are moved relative to one another.

Preferably on insertion or loading of the cartridge to the dispensing system, the driver acts or operates to bring the cartridge into an initial orientation (preferably the initial orientation positions cartridge compartments to a starting orientation prior to initiation of a cooking program).

Preferably the driver or a connector to the driver locates the cartridge within the dispensing system (preferably locking the cartridge in place).

Preferably a driver is engageable with the cartridge for actuating movement of the compartments and base portion relative to one another.

Preferably the driver is engageable with the cartridge via a connector (preferably the cartridge including a channel for receiving the driver or a connector of the driver).

Preferably the connector is bar engageable with a channel of the cartridge, the bar locating the cartridge.

Preferably the dispenser system comprises one or more liquid or liquid-based cooking ingredient nozzles for spraying the liquid or liquid-based ingredient in to the vessel.

Preferably the liquid or liquid-based ingredient is oil or water or liquid food ingredient.

Preferably the receiver is a stub receiver, receivable of the stub extending from a vessel.

Preferably the stub (or stubs) extending from an underside of the vessel is received by the stub receiver, engagement of the stub with the receiver locating or positioning the vessel at a preferred cooking off-set or tilt angle from vertical.

Preferably the stub(s) of the stub receiver(s) engage each other at a first position and at a second (preferably rotated) position the arm or blade stirrer for the vessel is engageable or becomes engaged with a driver.

Preferably at the second (preferably rotated) position, the arm or blade and vessel are in an operable position (preferably locked) together.

Preferably the stub and stub receiver are hollow.

Preferably the stub and stub receiver provide a passage for the measurement of temperature (preferably providing an uninterrupted pathway to the vessel for measurement of vessel temperature).

Preferably the stub receiver comprises a temperature sensor for sensing temperature of the vessel's cooking surface.

Preferably the stub receiver provides a protective housing or shroud for a temperature sensor for sensing temperature of the vessel's cooking surface.

Preferably the temperature sensor is an infra-red temperature sensor or a thermocouple.

Preferably the cartridge is as defined by any one of the first to fifth aspects above.

Preferably the vessel is as defined by the sixth aspect above.

Preferably the device is electrically operable with a fuel-gas heat source.

Also described herein is a cooking device for cooking a meal or a part of a meal, the device comprising: a receiver for a cooking vessel, such a cooking vessel including a cooking surface, a heat source for heating of the cooking surface, an arm or blade configured to move about the cooking surface for the moving of meal ingredients located thereon or within the vessel, and a dispenser system in communication with the vessel, the dispenser system configured for receiving a cartridge containing meal ingredients to be dispensed into the vessel for cooking at preferred or predetermined times during a cooking program.

Also described herein is a cooking device for cooking a meal or a part of a meal, the device comprising: a vessel including a cooking surface, a heat source for heating of the cooking surface, an arm or blade configured to move about the cooking surface for the moving of meal ingredients located thereon or within the vessel, and a dispenser system in communication with the vessel, the dispenser system configured for receiving a cartridge containing meal ingredients to be dispensed into the vessel for cooking at preferred or predetermined times during a cooking program.

Also described herein is a cooking device for cooking a meal or a part of a meal, the device comprising: a vessel including a cooking surface, a heat source for heating of the cooking surface, an arm or blade configured to move about the cooking surface for the moving of meal ingredients located thereon or within the vessel, and a dispenser system in communication with the vessel, the dispenser system configured for receiving of meal ingredients to be dispensed into the vessel for cooking at preferred or predetermined times during a cooking program.

Also described herein is a cooking device for cooking a meal or a part of a meal, the device comprising: a vessel including a cooking surface, a heat source for heating of the cooking surface, an arm or blade configured to move about the cooking surface for the moving of meal ingredients located thereon or within the vessel, and a dispenser system in communication with the vessel, the dispenser system configured for receiving and dispensing of meal ingredients to be dispensed into the vessel for cooking at preferred or predetermined times during a cooking program.

Also described herein is a cooking device for cooking a meal or a part of a meal, the device comprising: a vessel including a cooking surface, a heat source for heating of the cooking surface, an arm or blade configured to move about the cooking surface for the moving of meal ingredients located thereon or within the vessel, and a dispenser system in communication with the vessel, the dispenser system configured for receiving and dispensing of meal ingredients to be dispensed into the vessel for cooking at preferred or predetermined times during a cooking program, and wherein the dispenser system further administers (preferably as a spray) water or a water-based liquid into the vessel at preferred or predetermined times during the cooking program.

Also described herein is a cooking device for cooking a meal or a part of a meal, the device comprising: a vessel including a cooking surface (preferably the vessel removable from the device), a heat source for heating of the cooking surface, and an arm or blade configured to move about the cooking surface for the moving of meal ingredients located thereon or within the vessel, wherein the vessel's wall (or walls) include a first slot for receiving and locating (and preferably supporting) a first end of the arm or blade and a second slot for receiving and locating (and preferably supporting) a second end of the arm or blade, the second end engageable with a driver for moving the arm or blade about the cooking surface.

Also described herein is a cooking device for cooking a meal or a part of a meal, the device comprising: a vessel including a cooking surface (preferably the vessel removable from the device), a heat source for heating of the cooking surface, and an arm or blade configured to move about the cooking surface for the moving of meal ingredients located thereon or within the vessel, wherein one end of the arm or blade is receivable or locatable by a first section (preferably a recess or a slot) of the vessel's wall, and the other end of the arm or blade is supported by a second section (preferably a recess or a slot) of the vessel's wall, the other end of the arm or blade engageable with a driver for moving the arm or blade about the cooking surface.

Also described herein is a cooking device for cooking a meal or a part of a meal, the device comprising: a vessel including a cooking surface (preferably the vessel removable from the device), a heat source for heating of the cooking surface, and an arm or blade configured to move about the cooking surface for the moving of meal ingredients located thereon or within the vessel, wherein the cooking device further comprises of a stub receiver (or receivers) receivable of a locator stub (or stubs) extending from the vessel, the stub receiver(s) locating of the vessel at a pre-determined position when the vessel with locator stub(s) is/are received in-situ.

Also described herein is a method for preparing a meal or a part of a meal, the method comprising: selecting meal ingredients, the ingredients selected to form the or a part of a meal, arranging or having the selected meal ingredients arranged in a cartridge, the cartridge being receivable by a dispensing system communicable with a cooking device, the dispensing system programmable or automated for dispensing of the selected meal ingredients according to a preferred or pre-determined cooking program, the cooking program initiating or being initiated when the cooking device is operated or activated.

Also described herein is a method for preparing a meal or a part of a meal, the method comprising: a consumer selecting a plurality of ingredients to form the meal or at least a portion of the meal or at least a portion of the part of the meal, the selected ingredients being arranged into a cartridge by the consumer or for the consumer or at least some of the selected ingredients having been previously arranged into a cartridge, the cartridge being receivable by a dispensing system communicable with a cooking device, the dispensing system (preferably programmable or automated) for dispensing of the selected meal ingredients according to a preferred or pre-determined cooking program, the cooking program initiating or being initiated when the cooking device is operated or activated.

Also described herein is a method for preparing a meal or a part of a meal, the method comprising: a consumer selecting from an available list of meal ingredients, the ingredients selected to form the or a part of a meal,

the consumer selected meal ingredients arranged in a cartridge, the cartridge being compartmentalised, meal ingredients compartmentalised by food type or preferred cooking time or both, placing the cartridge into a dispensing system communicable with a cooking device, the dispensing system programmable or automated for dispensing of meal ingredients according to a preferred or pre-determined cooking program, and activating the cooking device to cook the meal ingredients according to the preferred or pre-determined cooking program.

Also described herein is a method for preparing a meal or a part of a meal, the method comprising: a consumer selecting from an available list of meal options or part of a meal options comprising meal ingredients, (preferably the meal options or the part of the meal options available are pre-arranged in a cartridge), (preferably the cartridge being compartmentalised, meal ingredients compartmentalised by food type or preferred cooking time or both), placing the cartridge into a dispensing system communicable with a cooking device, the dispensing system programmable or automated for dispensing of meal ingredients according to a preferred or pre-determined cooking program, and activating the cooking device to cook the meal ingredients according to the preferred or pre-determined cooking program.

Also described herein is a method for preparing a meal or a part of a meal, the method comprising: selecting a meal from an available list of meal options, the meal comprising all the ingredients for forming the selected meal, arranging or having the meal ingredients for the selected meal arranged in a cartridge, (preferably the cartridge being compartmentalised, meal ingredients compartmentalised by food type or by a preferred cooking time for some of the ingredients or both), placing the cartridge into a dispensing system communicable with a cooking device, the dispensing system programmable or automated for dispensing of meal ingredients according to a preferred or pre-determined cooking program, and activating or initiating the cooking device or having the cooking device activated or initiated to cook the meal ingredients (preferably according to a preferred or pre-determined cooking program).

Preferably the cartridge is compartmentalised and the selected meal ingredients are arranged within the compartments.

Preferably the meal ingredients are arranged in the cartridge or compartments of the cartridge, according to food type, or in order of a preferred or a pre-determined cooking duration(s), or both.

Preferably dispensing of meal ingredients from the cartridge to the cooking device by the dispensing system occurs at a preferred or pre-determined duration during a cooking program.

Preferably ingredients are dispensed from the cartridge according to food type, or in order of a preferred or a pre-determined cooking duration(s), or both.

Preferably the preferred or pre-determined cooking duration is determined by food type. Preferably the cooking device is programmable or automated for cooking meal ingredients dispensed according to a preferred or pre-determined cooking program.

Preferably a cooking surface of the cooking device is temperature controllable or controlled.

Preferably the cooking surface is controllable or controlled according to a preferred temperature or a pre-determined temperature during a cooking program.

Preferably at termination of the cooking program cooked meal ingredients are dispensed from the cooking device.

Preferably at termination of the cooking program meal ingredients are dispensed automatically from the cooking device to a meal receptacle.

Preferably the meal receptacle is a meal plate or bowl or a sealable container, such as a heat insulating container or the type having a container portion and a container sealing lid portion.

Preferably at termination of the cooking program meal ingredients are dispensed manually from the cooking device to a meal receptacle.

Preferably dispensing of cooked meal ingredients is performed using an arm or blade, moved in a direction to push the cooked meal ingredients food out of a cooking vessel.

Preferably the meal ingredients are arranged in the cartridge in a preselected combination.

Preferably the cartridge contains a preselected combination of meal ingredients.

Preferably one or more of the meal ingredients are pre-prepared before being arranged in the cartridge.

Preferably pre-prepared meal ingredients are pre-prepared according to one or more of size, shape or pre-cooking.

Preferably one or more of the meal ingredients are pre-cooked or partially cooked before being arranged in the cartridge.

Preferably ingredients are pre-prepared such that one or more of the ingredients (preferably all of the solid ingredients) can be dispensed together for cooking or be cooked in the same time or duration.

Preferably meal ingredients include one or more of solid food or liquid food or at least one solid and at least one liquid ingredient.

Preferably meal ingredients are a breakfast or a lunch or a dinner ingredients.

Preferably meal ingredients include one or more of ingredients of eggs or egg products, such as for an omelette, scrambled egg, potato or potato products, such as for hash browns, potato pieces or potato chunks, onions, tomato, pork or pork products such as bacon, sausages, beans such as baked beans or chilli-style beans or kidney beans, oats or rolled oats for porridge, dairy products, such as cream or milk.

Preferably meal ingredients are one or more of the following: solid foods, liquid foods, carbohydrate food forms, protein food forms, rice, noodles, semolina products, vegetables, fruit, nuts, seeds, poultry or poultry products, bovine or beef products, cervine or cervine products, leporids or leporid products, ovine or ovine products, porcine or porcine products, fish including shell fish or non-shell fish, condiments such as salts or spices, sauces or flavourings.

Preferably one or more liquid or liquid-based cooking ingredient(s) are sprayed in to the vessel (preferably via the dispensing system).

Preferably spraying is automatic according to one or more of a sensed cooking surface temperature or the predetermined cooking program.

Preferably the liquid or liquid-based ingredient is oil or water or liquid food ingredient.

Preferably, the cartridge is as defined in any one of the aspects above.

Preferably, the vessel is as defined in any one of the aspects above.

Preferably, the cooking device is as defined in any one of the aspects above.

Also described herein is a kit of parts comprising a cartridge as defined in any one of aspects one to five above, and a vessel as defined in the sixth aspects above, and a cooking device as defined in any one of the seventh to fifteenth aspects above.

Also described herein is a use of the cooking device according to the present invention for preparing a meal or a part of a meal.

Also described herein is a stir-fry meal prepared according to the method of the invention or by the cooking device of the invention.

For the purposes of this specification, poultry is generally defined as comprising of flesh or meat or parts of chickens or turkeys or ducks or geese or other birds raised or available as food for human consumption.

Advantageously, the cooking device of the present invention allows a stir-fry style method of meal preparation to be carried out. Further, advantages may be conveyed in assisting a stir-fry style method of meal preparation according to the use of a compartmentalised cartridge for containing food items or meal ingredients, such as solid and liquid foods (e.g. rice or noodles, meat, vegetables, sauces or other condiments), to be dispensed at preferred or predetermined times during a meal cooking operation.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

The invention and related aspects consists in the foregoing and also envisages constructions of which the following gives examples only.

### BRIEF DESCRIPTION OF THE DRAWINGS

Preferred embodiments of the invention and related aspects will be described by way of example only and with reference to the drawings, in which:

FIG. 1 illustrates a perspective view of one embodiment of a cooking device

FIG. 2 illustrates a front view of an embodiment of a cooking device with a vessel in-situ,

FIG. 3 illustrates a side view of one embodiment of a cooking device with a vessel in-situ

FIG. 4A is an end elevation view of one embodiment of a vessel,

FIG. 4B is a side elevation view of one embodiment of a vessel,

FIG. 4C is a top view of one embodiment of a vessel,

FIG. 5A is a side elevation view of one embodiment of a stirrer,

FIG. 5B is a top view of one embodiment of a stirrer,

FIG. 6 illustrates one embodiment of a cartridge,

FIGS. 7A and 7B illustrates an embodiment of components forming a cartridge,

FIG. 8 illustrates one embodiment of a cartridge,

FIG. 9 illustrates a top view of an alternative embodiment of a cartridge

FIG. 10 illustrates a section view through the cartridge of FIG. 9,

FIG. 11 illustrates a section view through the cartridge of FIG. 9 when the compartments opening aligns with central void space opening,

FIG. 12 illustrates in more detail an embodiment of a connector extending from the cartridge, and

FIGS. 13A and 13B illustrate in more detail an embodiment of a connector portion of a driver according;

FIGS. 14 and 15 illustrate, respectively, a top view and a bottom view of a further embodiment of a series of compartments,

FIGS. 16 and 17 illustrate, respectively, a top view and a bottom view of a further embodiment of a base portion,

FIG. 18 illustrates an assembled cartridge using the compartments and base portion of FIGS. 14-17,

FIGS. 19 and 20 illustrate sectional views through the assembled cartridge of FIG. 18, and

FIG. 21 illustrates an embodiment of a connector bar for engaging with and rotating the compartments of a cartridge.

### DETAILED DESCRIPTION OF PREFERRED EMBODIMENTS

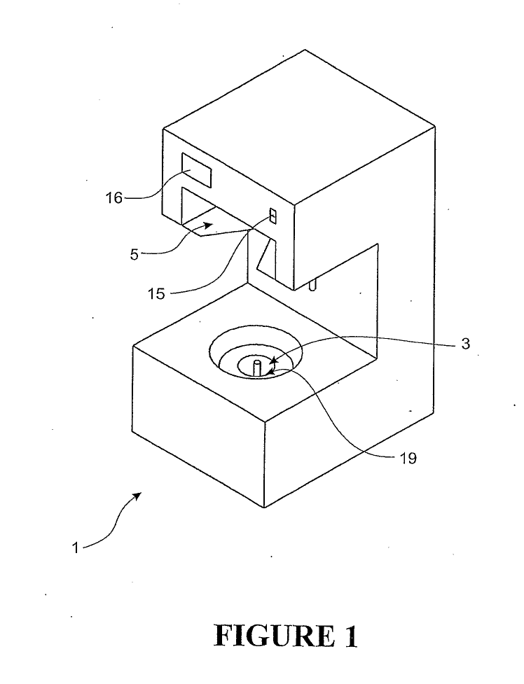

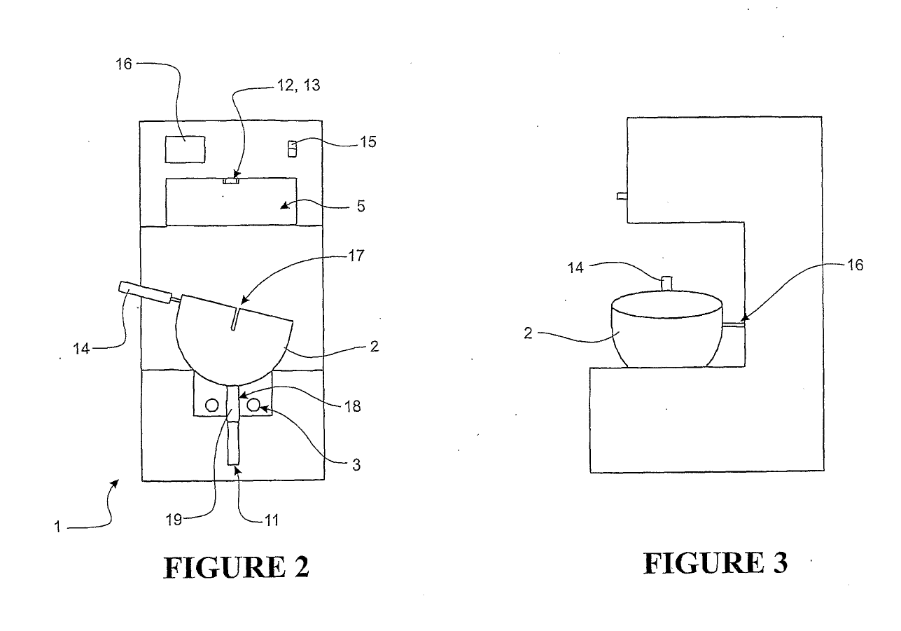

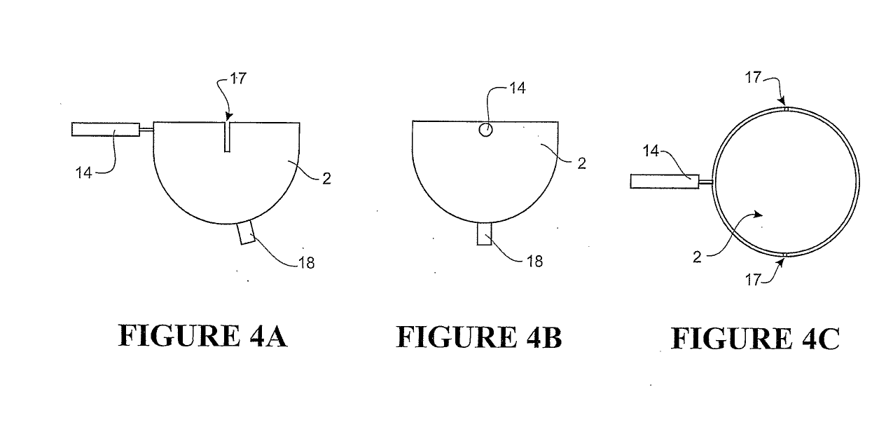

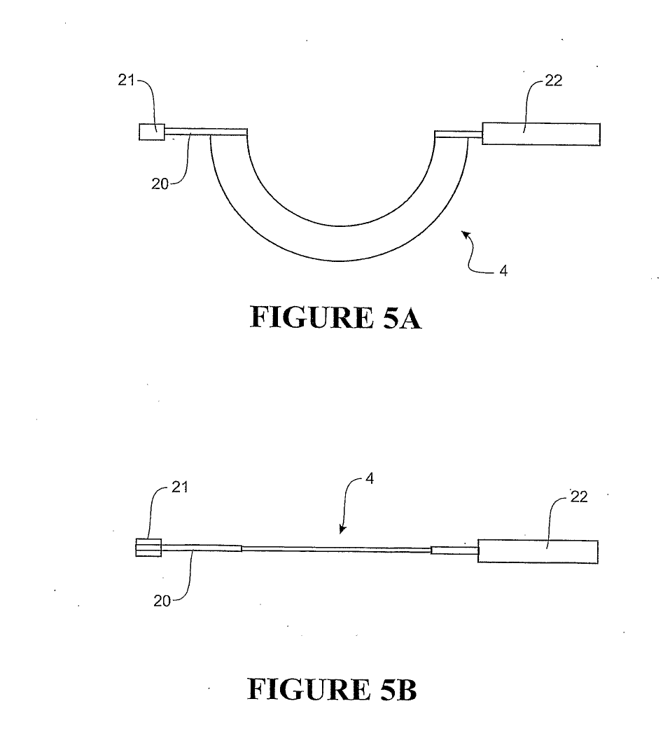

This invention is designed to facilitate the ease of preparation of a stir-fry style cooked meal. With reference to the accompanying FIGS. 1-13B, various aspects of the invention and other features are described below.

The present invention may be employed for preparing a meal or a part of a meal. The method comprises selecting of meal ingredients (not shown), the ingredients selected to form the or a part of a meal, arranging or having the selected meal ingredients arranged in a cartridge 6. The cartridge 6 is receivable by a dispensing system 5 communicable with a cooking device 1. The dispensing system 5 is programmable or automated for dispensing of the selected meal ingredients (not shown) according to a preferred or pre-determined cooking program, the cooking program initiating or being initiated when the cooking device 1 is operated or activated.

There may be provided a cooking device 1. The cooking device 1 comprises a vessel 2 including a cooking surface, a heat source 3 for heating of the cooking surface, an arm or blade 4 configured to move about the cooking surface for the moving of meal ingredients (not shown) located thereon or within the vessel 2, and a dispenser system 5 in communication with the vessel 2. The dispenser system 5 is configured for receiving a cartridge 6 containing meal ingredients (not shown) to be dispensed into the vessel 2 for cooking at preferred or predetermined times during a cooking program.

The cartridge comprises an enclosure 7 with a compartment or compartments 30, 8 for receiving meal ingredients (not shown), (optionally) a lid 9 (not shown) covering the compartment(s) 30, 8, and a base portion 10 for supporting contents of the compartment(s) 8. The cartridge 6 is configured such that a) the base portion 10 is removable or moveable relative to the compartment(s) 30, 8 or the enclosure 7, or b) the compartment(s) 30, 8 is/are moveable relative to the enclosure 7 or the base portion 10, or c) the enclosure 7 is moveable relative to the base portion 10.

Given the configuration, in use, contents (not shown) of one or more of the compartments 30, 8 may exit or be dispensed from the cartridge 6 at a preferred or predetermined time during a cooking program.

In one embodiment the cartridge may comprise a first part B and a second part A. The first part B is a substantially hollow enclosure 7 with a base portion 10, the base portion 10 sealing substantially the entirety of the bottom of the enclosure 7 apart from a segment void 34 and a central void 23. The central void 23 being in communication with a central void space 24 extending substantially centrally upwards of the base portion 10, the enclosure 7 and central void space 24 communicable by a central void space opening 25. The segment void 34 providing for dispensing of solid food ingredients from the compartments 8. And, a second part A being a substantially hollow enclosure 26 receivable within the first enclosure 7, one or more compartments 30, 8 formed within the second part's enclosure 7. The one or more of the compartments 30, 8 comprising of a compartment opening 27 in a compartment wall 28, the opening 27 alignable with the opening 25 of the first part B.

The method of preparing a meal or a part of a meal may comprise of a consumer selecting from an available list of meal ingredients (not shown), the ingredients selected to form the or a part of a meal. Arranging or having the consumer selected meal ingredients arranged in a cartridge 6, the cartridge 6 being compartmentalised, the meal ingredients compartmentalised by food type or preferred cooking time or both. Placing the cartridge 6 into a dispensing system 5 communicable with a cooking device 1, where the dispensing system 5 is programmable or automated for dispensing of meal ingredients according to a preferred or pre-determined cooking program and activating the cooking device 1 to cook the meal ingredients according to the preferred or pre-determined cooking program.

The cooking device 1 uses a heat source 3 to heat the cooking surface of the vessel 2. The heat source 3 can be of various types, but may for example be an ignited fuel, such as a fuel gas, typically as used with a ring burner. In various alternatives, the heat source 3 can be an electrically heated element, or an induction-type element when coupled with an appropriate vessel or cooking surface material. In one example the heat source is a nit mesh burner or a pre-mix air and gas system. Preferred heat sources are those, such as suitable burners, that are capable of rapidly heating of the vessel's cooking surface to an operational temperature. Such heat sources should also be those enabling fine control of high end power output and low end reduced power output for suitable temperature control of the cooking surface.

The temperature of the cooking surface is measurable using a sensor 11, such as for example an infra-red sensor. Thermocouples attached to parts of the vessel 2 can also be used. The sensed temperature of the cooking surface may be fed to a controller which compares the cooking surface temperature with a temperature set-point according to the preferred or predetermined cooking surface temperature during a cooking program.

Depending on the sensed temperature, the temperature of the cooking surface may need altering. For example, if the temperature needs increasing, the heat source 3 can be controlled to output more heat, such as by increasing the amount of fuel being ignited. Alternatively, if the cooking surface is too hot, the heat source can be controlled or adjusted to reduce the heat being outputted. In this manner, the cooking surface temperature can be controlled. The control of adjusting of the heat source 3 can be automated in conjunction with the temperature sensor 11 and a heat source controller (controller not shown).

Control of the cooking surface temperature may be particularly useful where, for example, different types of meal ingredients are being cooked during a cooking program. For example, the cooking of meats or vegetables often requires different temperatures. The temperature of the cooking surface can also be varied depending on a preferred or predetermined temperature during a cooking program coinciding with dispensing of meal ingredients from the cartridge 6 to the vessel 2.

The dispenser system 5 is able to be programmed or automated so meal ingredients from the cartridge 6 are dispensed according to a preferred or pre-determined period during a set cooking program. A variety of different cooking programs can be selected. For example, the cooking program will depend at least in part on the types of foods being cooked and may also depend on a user's preference, for example vegetables less cooked need less time exposed to heat of the cooking surface, whereas vegetables more cooked need more time exposed to heat of the cooking surface.

The cooking program can be activated by pushing a start button. The program can first instruct the vessel 2 to be heated to a certain temperature at which point, for example, oil can be dispensed into it. Then, once the vessel 2 reaches another predetermined temperature the solid and/or liquid food ingredients can be dispensed. There may be a sensor (not shown) which indicates if the cartridge 6 has been correctly loaded into the dispensing system 5. This sensor can be used to prevent the cooking program from starting if the cartridge 6 is not properly loaded, alternatively it could activate the cooking program.

The cartridge 6 is configured having an enclosure 7 for supporting of a compartment or compartments 30, 8 that are sized or shaped for receiving meal ingredients. Optionally, a lid 9 can be provided for covering the compartments 30, 8. The lid 9 can be multifunctional. For example, the lid may be used to cover an empty or unused cartridge, thereby keeping the compartments 30, 8 sterile or in a clean or hygienic condition. When the cartridge compartments 30, 8 need to be filled with meal ingredients the lid 9 can be removed and then replaced to prevent meal ingredients arranged in the compartments 30, 8 from being contaminated with dust, bacteria, bugs or other meal ingredients. The lid 9 can therefore be used as a way of sealing meal ingredients within the cartridge compartments 30, 8 for an extended period of time. The lid 9 can be applied in a factory where meal ingredients are prepared and arranged or placed into the compartments 30, 8 or applied by a user. The lid 9 therefore also helps in retaining the meal ingredients in the cartridge during transport operations. The lid 9 is removable. In one embodiment, the lid 9 may remain in place when the cartridge 6 is placed in the dispenser system 5, although in an alternative the lid 9 can be removed prior to the cartridge 6 being inserted into the dispenser system 5.

The cartridge 6 further includes a base portion 10 for supporting contents of the compartments 8.

Various alternative arrangements of a cartridge 6 configuration are contemplated. The different configurations are provided as means of allowing meal ingredients contained within the compartments 30, 8 to exit or be dispensed from the cartridge 6 into the vessel 2 at a preferred or predetermined time during a cooking program.

The way in which meal ingredients are dispensed from the cartridge 6 can be achieved in various ways.

For example, in one embodiment the base portion 10 can be removable or moveable relative to the compartment(s) 30, 8 or the enclosure 7. In another example, the compartment(s) 30, 8 are moveable relative to the enclosure 7 or the base portion 10. In yet a further example, the enclosure 7 is moveable relative to the base portion 10. Each example provides for the relative movement of the cartridge 6, enclosure 7, compartment(s) 30, 8 or base portion 10. Relative movement of the cartridges 30, 8 at facilitates meal ingredients contained within one or more compartments 30, 8 of the cartridge 6 to be moved to a position allowing dispensing of the meal ingredients into the vessel 2 for cooking.

The dispensing system 5 is activated or operable to dispense meal ingredients from the cartridge 6 at preferred or predetermined times according to a cooking program, the cooking program being initiated or activated when the cartridge is inserted into the dispensing system 5, or by a manual user over-ride activation.

It will be appreciated activation of the dispenser system 5 is coupled with the cooking device 1 for operation or activation of the cooking program which includes sensing of the cooking surface temperature and suitable adjustments. When the cooking surface reaches a preferred or predetermined temperature the first items of meal ingredients, such as meats, may be dispensed from compartments 30, 8 of the cartridge 6 via the dispensing system 5.

It will be appreciated the cartridge 6 can have two or more compartments 30, 8 for receiving meal ingredients. Each compartment 30, 8 may receive either a solid or a liquid meal ingredient, for example meat, vegetables, rice—liquid ingredients being placed into compartments 30 and solid ingredients being placed in compartments 8. Compartments may receive meal ingredients based on their order of being added to the vessel 2.

The compartments 30, 8 can be of the same or a different volume, although it will be appreciated the volume for solid ingredient compartments 8 may be larger than for those of liquid ingredient compartments 30. The compartments 30, 8 of the cartridge 6 can be configurable or designed to accommodate meal ingredients of different portion sizes or shapes, for example rice and peas may have similar sized compartments, whereas meat portions or other larger meal ingredients may need larger compartment sizing to accommodate their meal contribution portions.

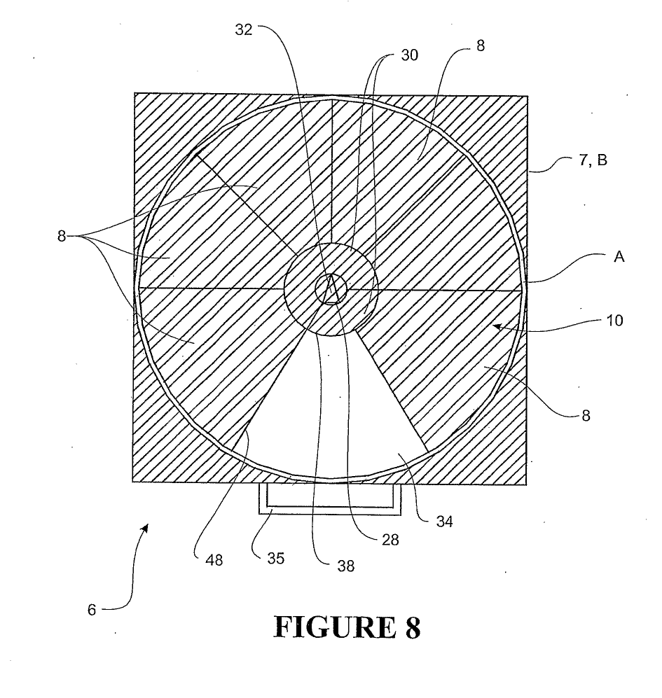

In one particular embodiment, the cartridge 6 is circular and with compartments 30, 8 spaced radially about the cartridge. Such an arrangement is illustrated by FIG. 8. In an alternative, the cartridge 6 can be formed or placed within a square or rectilinear shaped enclosure 7, forming for example a drawer.

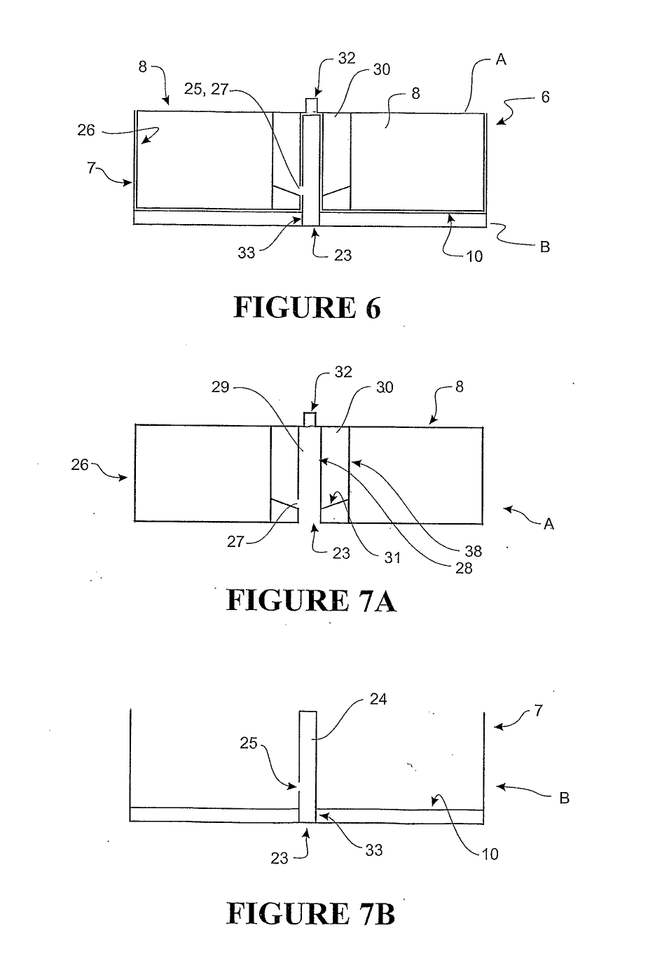

The cartridge 6 can be formed from the assembly of two or more components, such as illustrated by FIGS. 7A and 7B and an assembled version in FIG. 6. In the embodiment illustrated by FIGS. 7A and 7B the second part A can be formed to interlock or fittingly engage with the first part B. The first and second parts B, A can be assembled to form a cartridge 6. In this manner, it will be appreciated ease of manufacturing of cartridge 6 parts or components can be performed by injection moulding techniques. This may allow mass production of cartridges 6. For example, this may allow cartridges 6 to be produced at low cost. Those cartridges 6 can then be filled with meal ingredients in its compartments 30, 8, sealed with a lid and sold, for example in supermarkets.

Forming of the cartridge 6 from separate parts A, B can also facilitate the ease of sterilisation or washing of the cartridge before re-use.

The dispensing system 5 is preferably configured to receive the cartridge 6 in the form of a compartmentalised drawer, such a drawer optionally having a handle 35 for ease of handling. In this manner, the cartridge 6 can be slotted or slid into position within the dispensing system 5. The dispensing system 5 can include a sensor or switch which is activated when the cartridge 6 is appropriately positioned or engaged with the dispensing system 5. In order to actuate the cartridge 6 so that meal ingredients are dispensed from the various compartments 30, 8, the dispensing system 5 additionally comprises a driver 12 or a connector mechanism coupled to the driver.

Such a driver 12 is used to actuate the cartridge 6 such that the selected meal ingredients are dispensed from the cartridge 6 to the vessel 2 according to the cooking program being used. In various embodiments, the driver 12 can actuate the cartridge 6 via cartridge connector 32 such that the cartridge compartments 30, 8 can be moved relative to the enclosure 7 and base portion 10 (or the enclosure 7 can be moved relative to the compartments 30, 8 or base portion 10) allowing selected meal ingredients to exit or be dispensed from the cartridge 6. Rotation of the compartments 30, 8 is also required to align the compartment opening 27 with the central void opening 25 for dispensing of liquid ingredient via the central void space 24, 29 and out of the central void 23.

In one preferred configuration the first part B remains fixed in position or static, while the second part A housing the compartments 30, 8 is moved or rotated. In this manner, the compartments 30, 8 are brought or moved into dispensing positions, such as solid ingredient compartments 8 being moved into a position above the segment void 34 and the liquid ingredient compartments 30 being moved so their openings 27 align with the opening 25 of the central void space 24 of the first part B.

The driver 12 includes a connector portion 13 for connecting with and actuating the connector 32 of the cartridge 6 to dispense meal ingredients from the compartments 30, 8. When the cartridge 6 is received within the dispensing system, as well as holding part B in a fixed position, it is necessary for the internal part A to connect with a motor or driver 12.

In another preferred configuration, the top or upper end of the central void space 29 to part A has a spline or spindle or triangular or trapezoidal or other suitably shaped connector 32. The motor or driver 12 has a sympathetic receiving or engaging portion 13 for connecting with connector 32 to drive and thus rotate part A relative to part B. The connector part 13 of the driver 12 and of part A 32 are designed to slide or easily engage with each other. In this manner, the connector 32 or driver 12 are configured such that should the connector 32 be slightly out of radial alignment with the driver connector portion 13, then the driver portion 13 or the connector 32 will naturally rotate or move into alignment for engaging one another.

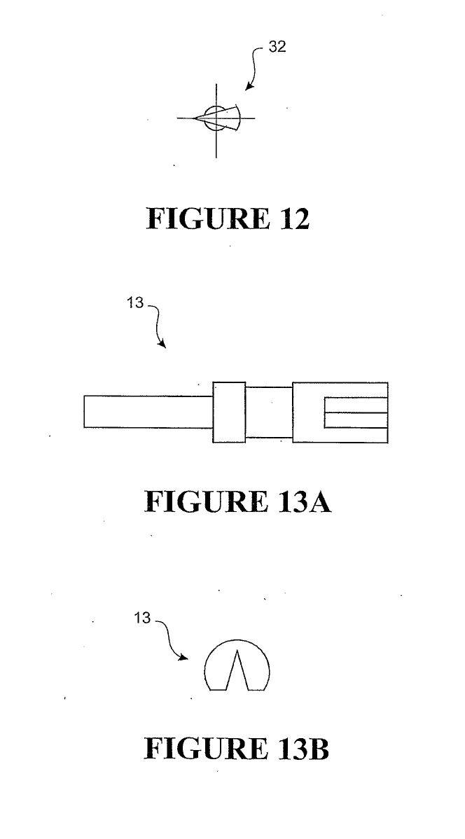

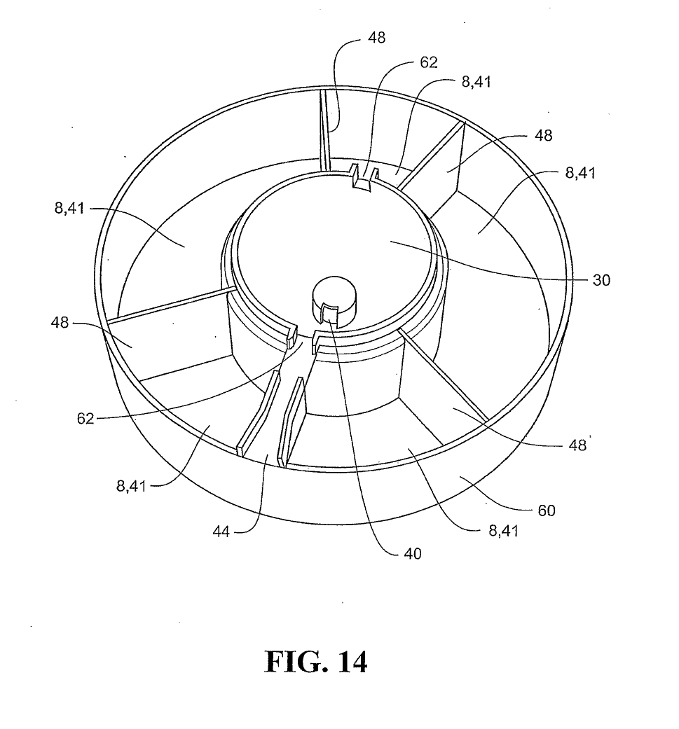

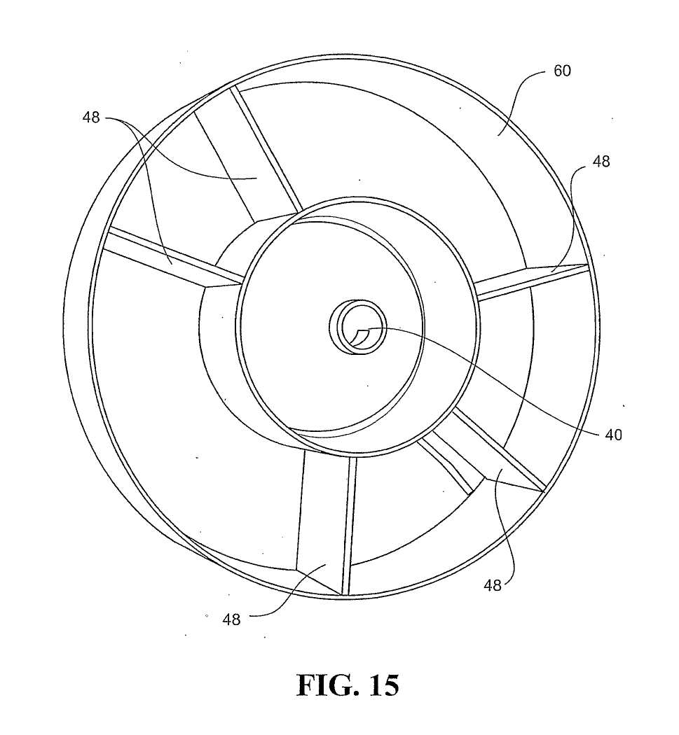

FIGS. 12, 13A and 13B illustrate the connectors 32, 13 showing one embodiment of how these parts may be able to engage with each other.

An alarm system can be coupled with the dispensing system 5 so any incorrect location of the cartridge 6 sets off a warning signal, such as a light or sound. The correct insertion angle of the cartridge 6 with the dispensing system 5 is designed to be easily discernible to a user with, for example, a clear front to the cartridge 6 aiding a user.

The cooking device 1 can optionally include an extractor fan (not shown). The extractor fan can be an in-built device located adjacent or positioned appropriately whilst not interfering with the segment void 34 or cartridge 6. The extractor fan provides suction for removal of cooking smells and gases. The extractor fan device can be connected to a portable or flexible hose to discharge of smells and gases away from the cooking device 1.

In an alternative however, a portable or flexible hose or conduit can be connected to a ducting (not shown) which can be substituted for the extractor fan, the hoses themselves connected to a central extraction device for sucking or removing of gases from the cooking device 1. For example, a portion of the dispenser system 5 can be rebated or filleted to provide an angle that allows a large enough space without interfering with the segment void 34 or cartridge 6. A fan can be installed in the filleted space for extracting cooking fumes. This may be particularly advantageous since large scale extraction in kitchens can be costly. Such a system may help localising extraction facilities into the device 1. Individual devices 1 can be connected via a flexible hose system to extract gases or fumes to an exterior location.

Advantageously, the cartridge 6 provides a means of automatically dispensing both solid and liquid food with a single rotary action driven by a driver 12 of the dispensing system 5.

An important aspect of being able to automatically stir fry food is being able to automatically dispense uncooked food items into the cooking vessel 2. Stir-fry style cooking methods usually involves the addition of oil, solid food particles and a sauce. Different types of solid food particles are common including meats and vegetables which need to be dispensed at different times during a cooking program. Similarly, oil is usually added at the beginning and the sauce at the end, though not necessarily.

Various types of rotary dispensers for automatically dispensing solid food particles are known in the art. Typically however, for dispensing liquid food, pumps or valves are used which are expensive and involve additional mechanisms that need cleaning and maintenance. In contrast, the invention helps provide for an integrated dispensing of solid and liquid components from a single unit or cartridge 6. Advantageously, that unit or cartridge 6 can be controlled by single rotary action, for example a single motor or driver (not shown, but part 16 of which extends to connect with the arm or blade 4).

The cartridge 6 may comprise two parts, a first part B and a second part A that fit or can be assembled together (as in FIG. 6) and that can be separated from each other with relative ease. The separate parts A, B can be separated for ease of cleaning, manually or in an automated device, for example a dishwasher.

As shown in FIG. 7B, there is a first part B of a generally hollow shallow cylinder shape with a base portion 10 substantially sealing or closing the entirety of the bottom or lower end portion of enclose 7, except for central void 23. The central void 23 is in communication with a central void space 24. The base portion 10 also includes a section or segment void 34 which does not seal or is not closed off, allowing for solid food ingredients to be dispensed from the cartridge 6 as the compartments 8 are moved into a position over the segment void 34.

The central void space 24 of the first part B includes an opening 25 in a lower end of its side wall. The side wall opening 25 provides for access or ingress of liquid food or liquid meal ingredients into the central void space 24 for dispensing into a vessel 2 during a cooking program. Liquids can drain through the central void space opening 25, enter the central void space 24 and then drain down out through the central void 23 into an awaiting vessel 2.

As shown in FIG. 7A, there is a second part A of a correspondingly shaped part configured to fit within the enclosure 7 or shell or external walls of the first part B. The second part A also includes a central void space 29 configured to fit snugly over or about the central void space 24 of the first part B. The fit or engagement of the second part within the first part's enclosure is advantageously in a sealingly engageable or abutting manner—preventing liquid leakage from inner liquid compartments 30.

Advantageously, the first and second parts fit together and form a seal about the central void spaces 24, 29 of their own accord. However, a tight fit of the parts A, B can assist in providing for automatic sealing of the compartment 30 opening 27. In this manner, only when the openings 25, 27 are aligned will liquid be allowed to drain from the compartment 30 into the central void space and out of the cartridge 6.

To assist with the snug or liquid tight fitment of the central void spaces 24, 29 with each other to prevent liquid leakages a sleeve can be used to surround the central void space 24 of the first part B, the sleeve forming a seal with the central void space 29 of the second part A when the first and second part B, A are engaged with one another. Such a sleeve can be formed of a plastic or elasticised or deformable material, a material that fills the gap between the external walls of each central void space 24, 29 and prevents liquid leakage is useful. Other valves or o-rings can be used for sealing any gap between the central void spaces 24, 29 for preventing liquid leakage from compartments 30. The sleeve or valve or o-rings should be positioned or formed such that the openings 25, 27 can be aligned and be in communication.

An assembled cartridge comprising the first and second parts B, A is shown by FIG. 6. The arrangement and ability for communication of the both openings 25, 27 and therefore the central void spaces 24, 29 is apparent from FIG. 6.

The second part A provides for one or a series of compartments 30 which can contain liquid meal ingredients. Such compartments can be configured for receiving liquid ingredients, holding the liquid and then dispensing the liquid when the openings 25, 27 of the compartment 30 and central void space 24, 29 are aligned.

More specifically, a compartment 30 to store and dispense of liquid ingredient includes an opening 27 in its side compartment wall that, when the compartment 30 is suitably rotated about the central void space 24 of the first part B, allows for alignment of the openings 25, 27 and liquid can freely flow out of the compartment 30 to the central void space 24, 29 and drain out through the central void 23 into an awaiting vessel 2. An aligned configuration of openings 25, 27 is illustrated by FIG. 6.

In the second part A, the compartments 30 have a floor portion 31 extending inwards and downwards toward the central void spaces 24, 29. In this manner, liquid is retained in the compartment 30 and directed toward the opening 25 for drainage out of the compartment 30 when the openings 25, 27 are aligned. The floor portion is angled such that liquid ingredients can preferentially drain or run off the surface by gravity. Additionally, an extension 33 of the central void space 24 below the base portion 10, such as for example in the form of a tube, further provides for direction of the liquid ingredient into an awaiting vessel 2. The extension can also assist as a drip edge, helping keep the cartridge in a clean and operational state.

Rotation of the compartments is as previously described, a driver can engage with the second part A or the first part B to rotate compartments relative to the central void space 24. In this manner, foods can be dispensed from the cartridge 6 according to a preferred sequence in a cooking program.

Liquid food compartments 30 can be arranged in a sequence interspersed with solid food compartments 8 according to a preferred cooking program or sequence of solid and liquid foods to be dispensed.

For example, in another embodiment, although not shown, a series of individual compartments can be arranged and be connectable to one another forming the compartments of part A. Where such a configuration is operated, the individual compartments can further engage with the second part A, for example with slots in an internal wall of part A to locate each of the compartments in a fixed position. The whole of part A can then be rotated by the driver, such as a stepper motor, within part B for dispensing of meal ingredients according to a cooking program.

In a further embodiment, extending outwardly from the central void space wall 28 of part A is a series of radial arms 48, the gaps between the radial arms 48 forming the compartments 8, 30. Such radial arms 48 extend out from the central void space 29 to an outer circular ring wall 38 that fits within the enclosure 7 or shell of part B. Inner compartments 30 adjacent the central void space 29 can be used as the liquid ingredient compartments. Those inner liquid ingredient compartments 30 are separated from outer solid ingredient compartments by the wall 38. For example, see the arrangement of compartments 30, 8 illustrated by FIG. 8.

The location of the radial arms 48 relative to the segment opening of part B determines at what sequence the solid ingredient components are to be dispensed. The location of the liquid compartment's opening 27 relative to the opening 25 of the central void space 24 determines at what sequence liquid ingredient components are to be dispensed. Such an embodiment lends itself such that with a singular rotary motion liquid and solid ingredient components can be dispensed simultaneously.

If only liquid ingredient is to be dispensed, then the corresponding outer solid ingredient compartment 30 that would otherwise be located over the base portion 10 section or segment which is not sealed or closed off and must be empty of meal ingredient. Similarly, if only solid ingredient is to be dispensed, then the corresponding inner liquid ingredient compartment 30 that then has its opening 27 (of part A) aligned with the opening 25 of part B must be empty of food. If wanted, both solid and liquid ingredients may be added simultaneously in which case both inner 30 and outer 8 compartments can be filled.

It is important there is created a seal between the second and first parts A, B such that liquid does not leak between the two central void spaces 24, 29 from liquid compartments 30. In some embodiments this can be achieved using central tubes as the central void spaces 24, 29 constructed having tight tolerances during manufacture. Alternatively, at least one part of the central void spaces 24, 29 can be made out of semi-flexible plastic so that it stretches inside of or over the other central void space 24, 29. In a further alternative, a sleeve (not shown) can be used between the two central void spaces 24, 29 or tubes having one or a series of seals, valves or o-rings (not shown) to prevent leakage.

In a preferred embodiment, a stepper motor driver (not shown) controls the location of part A relative to part B. Such a stepper motor can be programmed to rotate to a specific radial position. In this manner, a cooking program or sequence for dispensing of ingredients from compartments 30, 8 can be achieved.

In an even further embodiment, the cartridge 6 can be housed within a drawer, such as that illustrated by FIG. 8, and can be of any shape configured to be received by the dispensing system. For example, the exterior of the enclosure 7 or shell of part B can be formed in a square or rectangular shape. Such linear shapes may allow greater ease of handling by a user. The drawer can be shaped so it easily slides into a receiving void of the dispensing system like a drawer. In such a configuration, the external of the enclosure 7 or shell of part B can not rotate and so is held firmly in location by its shape and or by other locks for holding the drawer in position.

As well as holding the outer part B in a fixed position, it is necessary for the internal part A to connect with a motor or driver 12 allowing rotation. In a preferred embodiment, the top or upper end of the central void space 29 to part A has a spline or spindle or triangular or trapezoidal or other suitably shaped connector 32. See for example FIG. 12 as one embodiment of a suitably shaped connector 32. Then, the motor or driver 12 can have a sympathetic receiving or engaging portion 13 (see for example FIGS. 13A and 13B) for connecting with connector 32 to drive the connector 32 and thus rotate part A relative to part B. The connector part 13 of the motor 12 and of part A 32 are designed to slide or easily engage with each other. In this manner, the connector 32 or driver are configured such that should the connector 32 be slightly out of radial alignment with the driver connector portion, then the driver or the connector 32 will naturally rotate or move into alignment.

An alarm system can be coupled with the dispensing system so any incorrect location of the cartridge sets off a warning signal, such as a light or sound.

The correct insertion angle of the cartridge 6 with the dispensing system 5 is designed to be obvious with, for example, a clear front to the cartridge 6 aiding a user.

The compartments 8 of the cartridge 6 are supported by the base portion 10, until such time as the compartments 8 are rotated relative to the base portion 10 and solid food ingredients can be dispensed via the segment void 34. In such an embodiment the driver 12 can actuate the cartridge 6 such that compartments 30, 8 can be moved within the enclosure 7 until a compartment 8 containing solid meal ingredient is located over the segment void 34, or if the base portion 10 is being rotated, the solid ingredients in a solid compartment 8 are exposed. Liquid ingredient can be dispensed when the openings 25, 27 of the compartment 30 and central void space 24, 29 are aligned. When such a rotation made, at the point the solid meal ingredients are no longer supported by a base portion 10 the solid ingredients are free to fall from the cartridge 6 into the vessel 2 for cooking.

Advantageously, the cartridge 6 is configured to be robust, cheap to produce, relative ease of fitting the parts together and to also separate them simply, and are easily cleanable.

The dispenser system 5 is positioned such that meal ingredients contained within the compartments 8 are allowed to fall or be dispensed into the vessel 2. One preferred position for the dispense system 5 is overhead of the vessel 2.

The dispenser system 5 is optionally activated upon insertion of a cartridge 6. This activation may simultaneously activate the cooking device 1 in preparation for carrying out a preferred or predetermined cooking program. On/off switch 15 is also provided for powering of the cooking device 1. A time elapsed during a cooking program or time to complete the cooking program can be shown in a display 16.

The cooking program can be selected by a user of the cooking device 1. The cooking program is an automated sequence of steps for dispensing of meal ingredients from the cartridge 6 into the vessel for cooking. Meal ingredients can be arranged in a cartridge 6 according to the sequence they must be cooked, in or a preference of cooking. This may in part depend on a user's meal preferences, although it may also depend on the meal ingredients to be cooked.

The cooking device 1 can also be operated in an automated manner in conjunction with the cooking program selected by the user. The cooking program may also include operation of the arm or blade 4 for the stirring of meal ingredients in the vessel 2 and across or about the cooking surface. In this manner, the arm or blade 4 can be consider a stirrer or a scraper. Operation of the stirrer or scraper can also be automated to begin operation when the cooking program is started and end operation when the cooking program is complete.

Operation of the stirrer, such as the number of rotations or speed of rotation can also be dictated by the sensed temperature of the cooking surface.

In various aspects, the arm or blade 4 preferably contacts at least part of the cooking surface. In one embodiment the arm or blade 4 can have undulations or cut-away sections from the part of the arm or blade 4 that would otherwise come into contact with the vessel surface. The arm or blade 4 can be driven to rotate in a substantially horizontal manner. The arm or blade 4 can be moved about the cooking surface or the cooking surface and the vessel's 2 internal surface via a driver 16 or motor (not shown) located within the cooking device 1. The arm or blade 4 can be connected to the motor or driver by a linkage or articulation 16.

A slot 17 is provided in the wall of the vessel 2 for receiving an extension 20 of the arm or blade 4. The extension 20 of the arm or blade 4 rests in the slot 17 and is held in place by an end locator 21, the other end 22 of which is also adapted to rest within a slot extends out from the vessel's wall and connects to the driver 16 for rotation. In this manner, the arm or blade 4 is rotated about a substantially horizontal axis to move ingredients about the inside surface of the vessel 2. Ingredients are moved up the walls of the vessel 2 until the ingredients fall back down to the vessel's cooking surface, thus rotating ingredients about for achieving a preferred stir-fry style method of cooking.

In one embodiment the slots 17 are provided slightly too deep and under its own self-weight or alternatively by one or more resiliently flexible or biasing devices, such as springs, the arm or blade 4 is biased or tended towards the cooking surface of the vessel 2. In another configuration, the arm or blade 4 can be driven via a direct connection extending through an underside of the vessel 2.

One end of the arm or blade 4 preferably sits or rests on the base of one of the section (or slot), such an end of the arm or blade 4 engaging with the driver. This engagement for example by a coupling or connector mechanism where a leading edge of a male component of the arm or stirrer blade has a first taper, and where a receiving female part on the driver or connector mechanism has a second inverse taper. The receiving female part has an outer cover that is rotatable to allow engagement with the male part of the arm or blade 4, the outer cover configured for closing about the male part of the arm or blade 4 to lock in place. In this manner, the arm or blade 4 can be engaged in a position ready for a cooking operation. The automatic closing of the outer cover may be performed by springs connected to the cover. The nature of such an engagement meaning that both the arm or blade 4 and the vessel are locked into a (second) ready-to-operate position.

The other end of the arm or blade 4 preferably sits just above the base of the other section (or slot) when the arm or blade 4 is at its lower-most position of travel across the cooking surface of the vessel. In such a configuration, this means the arm or blade 4 is itself not supported by the section (slots) in the vessel but instead by the base of the vessel supporting the actual blade itself. Such a setup providing a means by which the arm or blade 4 scrapes the cooking surface of the vessel.

Scraping is effectively achieved by the end connected to the driver or connector mechanism (preferably in a hinged manner) effectively being a pivot point while the self weight of the stirrer blade tends to rotate the arm or blade 4 down towards the cooking surface. That pivot action being assisted by means of a hinge at the end of the stirrer blade that is supported by the first section (or slot).

The vessel 2 can be of any desirable shape or configuration, although a hemispherical shape may be most appropriate. Such a shape can allow meal ingredients to be retained within the vessel 2 during a cooking program and when stirred by the arm or blade 4. The vessel 2 can also include vertical extensions at the upper edge of such a hemispherical shape to help contain meal ingredients within. This extension may also help to contain ingredients when being moved by the arm or blade 4, enabling the ingredients to fall back to the base of the vessel 2 or onto the cooking surface in a different orientation to its prior position or orientation on the cooking surface—this enabling a stir-fry style method of cooking.

The vessel 2 optionally also includes a meal dispensing spout region (not shown). The meal dispensing spout region allows a cooked meal to be moved to the spout by the arm or blade 4 and dispensed into a waiting container or plate for serving food to a customer or user of the device 1 for consumption. For example, the meal can be dispensed from the spout into a waiting heat insulating container. The arm or blade 4 can be programmed to move in a particular manner once the cooking program is complete, in this manner providing for a more fully automated method of meal preparation and serving. Alternatively, cooked ingredients can be manually dispensed by a user by removing the vessel 2 from the receiver 18, then manually manipulating the arm or blade 4 to move ingredients from the vessel 2 to the spout.

The cooking device 1 can optionally comprises a vessel 2 receiver or receiving device 19. Such a receiver or receiving device 19 can locate the vessel 2 in a preferred cooking position during a cooking program. The receiver 19 can hold the vessel in the preferred cooking position, such as a tilted or off-set position from the vertical. Such an angle may assist with the movement and rotation of solid meal ingredients about the vessel 2.

The receiver 18 can receive a stub 19 extending from the vessel 2 and both can be hollow allowing an infra-red temperature sensor to be mounted underneath of the vessel 2 for sensing of the temperature of the vessel's cooking surface. The vessel can also be held at a slight tilt from the vertical during a cooking program. The tilt can be determined by the engaging of the vessel 2 stub 18 with the receiver 19, or the angle of the stub 18 extending from the vessel 2. Ideally, the infra-red sensor uses the hollow void of the stub 18 and receiver 19 to measure vessel surface temperature, the receiver 19 and stub 18 being absent of flames when an ignited fuel heat source 3 is used.

The vessel 2 can includes a handle or handles 14. The handle or handles 14 can be heat insulated or formed of wood or timber. The vessel 2 can be made of any suitable cooking material; preferably however the vessel 2 is a spun steel such as a carbon steel.

From the above it will be appreciated the cartridge 6 can be loaded with meal ingredients. The meal ingredients can be selected by a user and those ingredients arranged in the cartridge 6 compartments 8. The meal ingredients are desirably arranged in the cartridge 6 by i) food type or ii) in order of a preferred or a pre-determined cooking duration(s) or iii) both i and ii.

A prepared cartridge 6 with meal ingredients already loaded into the compartments can be provided. In this manner, a user of a cooking device 1 can purchase a cartridge 6 pre-loaded with ingredients. Ingredients can be arranged in the cartridge 6 according to cooking programs or meal types preferred (i.e. chicken stir-fry, or beef stir-fry or vegetarian stir-fry). Such meal ingredients are arranged in the cartridge 6 in preselected combinations.

Cartridges 6 can be supplied with one or more of the meal ingredients already pre-prepared, the ingredients requiring only minor additional cooking for preparation as part of a meal.

It will be appreciated there are a large variety of meal ingredients that can be used for preparing a meal. One or more of the meal ingredients can be pre-cooked or partially cooked before being arranged in the cartridge for further cooking in the device 1.

The meal ingredients can be those used as a breakfast or a lunch or a dinner.

The meal can include one or more of solid food or liquid food or both. For example, meal ingredients can be selected from one or more of the following: carbohydrate food forms such as rice or noodles or semolina products, vegetables, fruit, nuts, seeds, poultry or poultry products, bovine or beef products, cervine or cervine products, leporids or leporid products, ovine or ovine products, porcine or porcine products, fish including shell fish or non-shell fish, condiments such as salts or spices, sauces or flavourings.

The meal ingredients can also include one or more of ingredients of eggs or egg products, such as for an omelette, scrambled egg, potato or potato products, such as for hash browns, potato pieces or potato chunks, onions, tomato, pork or pork products such as bacon, sausages, beans such as baked beans or chilli-style beans or kidney beans, oats or rolled oats for porridge, dairy products, such as cream or milk.

The various forms of the invention and related aspects described above preferably allow for the ease of preparation of a cooked meal. The cooking device 1 and dispenser system 5 providing for an automated means of cooking meal ingredients. The meal ingredients are supplied to a cooking surface at predetermined times according to the ingredient type and style of meal to be prepared. Advantageously a stir-fry style method of meal preparation can be performed by the cooking device 1 when charged with meal ingredients from the cartridge 6 at the appropriate time during a cooking program.

the dispenser system 5 may alternatively or additionally include systems for administration of liquid or liquid-base ingredient via one or a series of spray nozzles. Such ingredient may be oil, water or sauces. Preferentially, the nozzles provide a metered or spray or dosing of water or an aqueous solution into the cooking vessel. Spraying may take place at predetermined times during a cooking program or may, for example, be made in response to a sensed temperature of the vessel's cooking surface.

Further embodiments are provided of a method for preparing a meal or a part of a meal.

In one such embodiment a method comprises selecting meal ingredients, the ingredients selected to form the or a part of a meal and then arranging or having the selected meal ingredients arranged in a cartridge 6. The cartridge 6 is receivable by a dispensing system 5 communicable with a cooking device 1, the dispensing system 5 is programmable or automated for dispensing of the selected meal ingredients according to a preferred or pre-determined cooking program, the cooking program initiating or being initiated when the cooking device 1 is operated or activated.

In another embodiment such a method comprises a consumer selecting a plurality of ingredients to form the meal or at least a portion of the meal or at least a portion of the part of the meal. The selected ingredients are then arranged into a cartridge 6 by the consumer or for the consumer or at least some of the selected ingredients having been previously arranged into a cartridge 6. The cartridge 6 is receivable by a dispensing system 5 communicable with a cooking device 1, the dispensing system 5 providing (preferably programmable or automated) for dispensing of the selected meal ingredients according to a preferred or pre-determined cooking program, the cooking program initiating or being initiated when the cooking device 1 is operated or activated.

In another embodiment such a method comprises a consumer selecting from an available list of meal ingredients, the ingredients selected to form the or a part of a meal. The consumer selected meal ingredients are then arranged in a cartridge 6, the cartridge 6 being compartmentalised; meal ingredients compartmentalised by food type or preferred cooking time or both. The cartridge 6 is then placed into a dispensing system 5 communicable with a cooking device 1, the dispensing system 5 programmable or automated for dispensing of meal ingredients according to a preferred or pre-determined cooking program. The cooking device is then activated to cook the meal ingredients according to the preferred or pre-determined cooking program.

In another embodiment such a method comprises a consumer selecting from an available list of meal options or part of a meal options comprising meal ingredients, (preferably the meal options or the part of the meal options available are pre-arranged in a cartridge 6). Also preferably the cartridge 6 is compartmentalised, with the meal ingredients compartmentalised by food type or preferred cooking time or both. The cartridge 6 is then placed into a dispensing system 5 communicable with a cooking device 1, the dispensing system 5 programmable or automated for dispensing of meal ingredients according to a preferred or pre-determined cooking program. The cooking device 1 is then activated to cook the meal ingredients according to the preferred or pre-determined cooking program.

In another embodiment such a method comprises selecting a meal from an available list of meal options, the meal comprising all the ingredients for forming the selected meal. Then, arranging or having the meal ingredients for the selected meal arranged in a cartridge 6. The cartridge 6 can be compartmentalised, with meal ingredients being or having been compartmentalised by food type or by a preferred cooking time for some of the ingredients or both. The cartridge 6 is then placed into a dispensing system 5 communicable with a cooking device 1, the dispensing system 5 programmable or automated for dispensing of meal ingredients according to a preferred or pre-determined cooking program. The cooking device 1 is then initiated or activated to cook the meal ingredients, for example according to a preferred or pre-determined cooking program.

Further embodiments are provided of a cartridge for retaining and dispensing of ingredients of a meal or at least a part of a meal.

In one such embodiment a cartridge 6 comprises at least one compartment segregated from one another by dividers or walls (for example radial arms 48), and a base portion 50 to the compartments 30, 8. Together the compartments and base portion define a receptacle. The compartments and the base portion are engageable with one another yet are moveable relative to each another (preferably forming a liquid-tight seal).

In another embodiment such a cartridge 6 comprises at least one compartment 30, 8 (preferably, the compartments are partitioned from one another by dividers or walls, for example radial arms 48) and a base portion 50. Together the base portion 50 and at least one compartment 30, 8 define a receptacle for retaining ingredients. The compartments 30, 8 and base portion 50 being engageable with one another and being moveable relative to each other. And, where at least one of the compartments 30, 8 includes at least a first aperture 40, 41 and the base portion 50 includes at least a second aperture 42, 43. In use, the first aperture 40, 41 of the compartments 30, 8 is communicable (preferably alignable) with the second aperture 40, 41 providing for an outlet passage from the compartment through the base portion (preferably to an awaiting vessel). The first and second apertures 40, 41, 42, 43 are communicable (preferably alignable) by movement of the compartments and base portion relative to each other (preferably being aligned with one another at a preferred or predetermined time during a cooking program).

As shown by the figures, at least one of a first compartment 30 is provided and at least one of a second compartment 8 is provided. The or each first compartment 30 includes a first aperture 40 (hereinafter a “first compartment aperture”) to allow ingredient to pass therethrough Likewise, the or each second compartment 8 includes a first aperture 41 (hereinafter a “second compartment aperture”) to allow ingredient to pass therethrough.

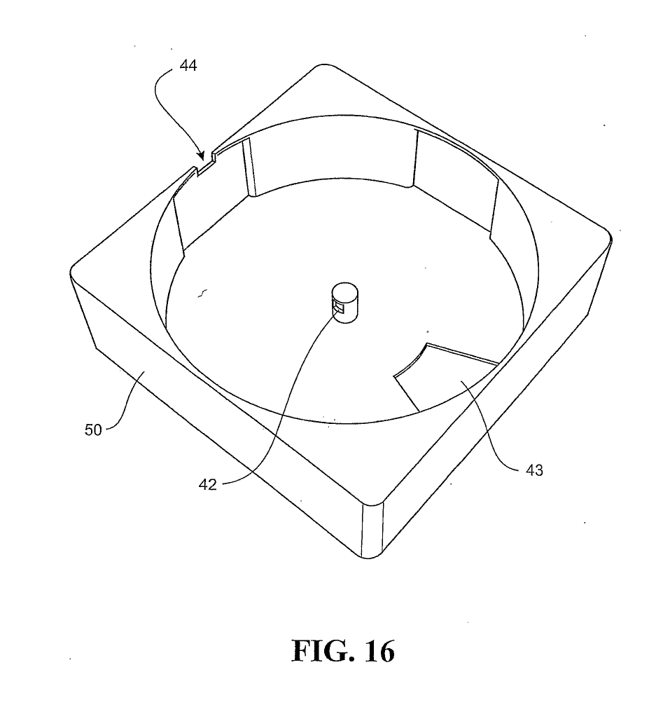

As illustrated by FIGS. 14-20, the first compartment aperture 40 is communicable with a second aperture 42 of the base portion 50 (hereinafter a “first base portion aperture”) providing for an outlet passage from the first compartment 30 when in aligned communication. The apertures 40, 42 are alignable by movement of the compartments and base portion relative to one another. As also illustrated by FIGS. 14-20, the second compartment aperture 41 is communicable with a second aperture 43 of the base portion (hereinafter a “second base portion aperture”) providing for an outlet passage from the second compartment 8 when in aligned communication. The apertures 41, 43 are alignable by movement of the compartments and base portion relative to one another. The driver engaging of the cartridge provides for movement of the compartments relative to the base portion, in according with a cooking program sequence.

As shown, the first aperture 40, 41 is located at the floor or base of a compartment. However, in other forms the first aperture can be located in a side wall of a compartment, for example as shown by location 27 in FIGS. 6, 7A, 7B.

Further embodiments are provided of a vessel 2 for cooking of meal ingredients.

In one such embodiment the vessel comprises an inner cooking surface (preferably being of a substantially hemispherical configuration), and a locator stub (or stubs) 18 extending from an outer surface of the vessel. The stub 18 is for locating of the vessel 2 at a pre-determined position (e.g. relative to the cooking device 1) when the locator stub(s) 18 is/are received by a stub receiver 19 of a cooking device 1. Such a the vessel's wall (or walls) also includes a first slot for receiving and locating (and preferably supporting) a first end of an arm or blade 4 and a second slot for receiving and locating (and preferably supporting) a second end of the arm or blade, the second end of the arm or blade of which is engageable with a driver (or motor connector 16 intermediate thereof) for moving the arm or blade about the inner cooking surface.

In another embodiment such a vessel comprises an inner cooking surface (preferably being of a substantially hemispherical configuration), and a locator stub (or stubs) 18 extending from an outer surface of the vessel, the stub 18 for locating of the vessel 2 at a pre-determined position when locator stub(s) is/are received by a stub receiver 19 of a cooking device 1. Further, one end of an arm or blade 4 is receivable or locatable by a first section (preferably a recess or a slot) of the vessel's wall, and the other end of the arm or blade is supported by a second section (preferably a recess or a slot) of the vessel's wall, the other end of the arm or blade engageable with a driver (or motor connector 16 intermediate thereof) for moving the arm or blade about the cooking surface.

In another embodiment such a vessel comprises a receiver for a vessel 2 including a cooking surface, a heat source 3 for heating of the cooking surface, an arm or blade 4 configured to move about the cooking surface for the moving of meal ingredients located thereon or within the vessel 2, and a dispenser system 5 in communication with the vessel. The dispenser system 5 is configured for receiving of meal ingredients to be dispensed into the vessel 2 for cooking at preferred or predetermined times during a cooking program.

This invention and related aspects provides for a process whereby a customer is able to select ingredients for their meal, those ingredients are placed into a cartridge, that cartridge is inserted into a cooking device (machine). The cooking device dispenses the ingredients from the cartridge according to a predetermined program and cooks them in a vessel. When cooked, or when the predetermined program is completed (for cooking of the meal ingredients) the cooked meal is then supplied to the customer. In one embodiment, the cartridge is able to be loaded either by the customer or by an operator, and ingredients selected either according to predesigned combinations or each ingredient individually selected by the consumer, or a combination of both can be used for creating a meal to be cooked.

As discussed, the ingredients may have a level of pre-preparation prior to being selected by the customer and being placed into the cartridge. This preparation can include one or more of washing, cutting, peeling, or pre-cooking one or more of the ingredients. Such preparation may help ensure that the overall cooking process is fast for the customer, therefore being applicable to use in fast food. Additionally, this preparation of ingredients can be complementary or designed in such a way that the pre-determined cooking programme allows for cooking the ingredients to an optimal level. For example, some types of food take longer to cook than others, but if they are cut to be a smaller size or shape then they can be made to cook in the same time as another type of food that is of a larger size or different shape. Similarly, if a type of food is difficult or undesirable to be cut into too small a size (e.g. vegetables such as broccoli) then such ingredients may be blanched or steamed first so that it also ends up cooking in the same time as the other ingredients.

Pre-preparation of ingredients can help with effective programming of the cooking program to ensure ingredients are sufficiently cooked for a customer (or optimally if such a food requires a certain amount of cooking before consumption). Understanding of the cooking times for different ingredients (individually or when being cooked with other ingredients) can be conducted in an empirical manner, the data from which can then be programmed into a controller for operating the cooking device and determining the predetermined cooking program.

The pre-preparation of ingredients can also extend to sauces, such as for where a sauce that may be used in cooking and would normally involve multiple ingredients is pre-made, for example off-site at a centralised ingredient preparation location.

Further, the pre-preparation of ingredients provides an opportunity to complete earlier or certain stages of meal cooking in advance of a customer arriving and selecting of a meal to be cooked. For example, in stir fry cooking it can be considered desirable that the meat is cooked first then removed, then the vegetables cooked, the meat returned and sauce added. This ensures the meat and vegetables retain their own flavour. It is possible for the first stage of meat being cooked to be completed in advance, eliminating the need for such ingredient to be completely cooked in the vessel or at the consumer stage of the cooking process.

The specification for preparation of ingredients and programming of the machine is also able to be designed by experienced or expert chefs and replicated throughout numerous restaurant or food outlets. Such a specification is able to be adjusted and improved or refined over time, with each improvement able to be replicated across numerous outlets.

In addition, the combination of a machine performing the cooking and one or more of the ingredients being pre-prepared according to a specification may assist in the quality control of cooking if certain ingredients, ensuring consistent product to customers.

Advantageously, this invention and related aspects allows for meals to be cooked without the need for skilled labour, such as a chief. Such a model helps to significantly reducing operating costs, including the labour cost reduced both by a machine doing work that humans would otherwise.

As also discussed above, the cartridge is able to contain both solid and liquid ingredients. In this manner, meals such as stir fry where there are usually solid ingredients such as meats and vegetables, and liquid ingredients such as a sauce, are able to be dispensed and cooked.

Where there is provided the automatic addition of liquid cooking ingredient (such as oil, water or water-based ingredient) from the dispenser system, advantageously this water or other liquid is added in small volumes, ideally sprayed (such as from a jet or nozzle), so as to keep the ingredients at an optimal level of hydration. This addition of liquid may assist with cooking of the ingredients and therefore reduced cooking times, lending the process further to applications of fast food. Such addition is separate to liquid ingredient dispensed from the cartridge. Further, the utilisation of small quantities of water to assist the cooking process can lead to a healthier cooking process with less oil needing to be used. It is considered the addition of small quantities of water on a regular basis, ideally in a spray form, helps produces tastier food than larger volumes of water provided more infrequently. Regulating the addition of such liquid ingredient by a spray jet or nozzle means small volumes of the liquid can be dispensed over the entire cooking surface or a large part of the cooking surface. The use of less oil in the cooking process can beneficially lead to healthier cooking.

The liquid ingredient can be stored in a central locality (for example in a store) to be fed to the dispenser systems of multiple cooking devices. In this manner, a bulk batch of liquid ingredient can be provided for administration to multiple cooking devices, further assisting in consistency of ingredients being added to the cooking vessel. Such an administration system may provide for further efficiencies in the preparation of meals for consumers—rather than such liquid ingredient being added as part of the ingredients to the cartridge.

As the cartridge is designed in such a way as to be economic to produce and easily cleaned, a ready supply of clean cartridges can be more cost effectively provided for meeting high customer demand. As described previously, such cartridges can be produced of plastics by injection moulding and be formed of two parts that can be separated easily for cleaning purposes.

The cooking vessel 2 is also easily removeable from the cooking device, much like a traditional wok, so the vessel 2 can be transported to a dispensing area for the meal (e.g. on to a plate or into a container or meal receptacle) and then to a cleaning station.

### EXAMPLE 1

A user takes a clean first part B and a clean second part A, shown by FIGS. 7A, 7B and assembles these together to form a cartridge 6, shown by FIG. 6.

The cartridge 6 has solid ingredient compartments 8 and liquid ingredient compartments 30. The user loads solid and liquid ingredients into the respective compartments in a loading sequence according to the order in which the solid or liquid ingredients (or both) are to be dispensed as the compartments 30, 8 are rotated while the first part B remains fixed in position. Rotation is provided to the compartments by engaging the connector 32 of the second part A with the connector 13 of the driver 12 from the dispensing system 5.

The user places a vessel 2 in position with the cooking device 1 by engaging the stub 18 with the receiver 19. The angle of the stub 18 as it extends from the vessel 2 determines the angle or tilt at which the vessel 2 will be held from the vertical.

The arm or blade 4 is positioned within the slots 17 with an end 21 connecting with driver or motor connector 16. Advantageously, the receiver 19 locates the vessel 2 by receiving the stub 18 (i.e. in a first position), the vessel is then moveable (such as by rotation of the stub within the stub receiver) to a second position such that the arm or blade 4 becomes engaged with the driver or motor connector 16. In such a position the vessel 2 and arm or blade 4 are engaged with the cooking device ready for a cooking operation.

When the cooking program is being run, the driver or motor will operate to rotate the arm or blade 4 to move meal ingredients about the vessel's surface. In one operative condition, the arm or blade remains in the slots 17 and attached to the vessel 2 under its own self-weight. The blade can remain substantially in contact with the vessel's cooking surface under its own self-weight during its path of travel.

The vessel 2 and arm or blade 4 is separable for ease of washing after a cooking operation.

The user switches the cooking device 1 on. The cooking device 1 is now ready for performing or running a cooking program. The cooking program can be selected from a menu display or option buttons (not shown) on the device 1.

The loaded cartridge 6 is inserted into the dispensing system 5 until the connector 32 of the second part A engages with the connector 13 of the driver 12. When the connectors 32, 13 are engaged with each other the cartridge 6 is ready for operation and dispensing of meal ingredients. Rotation of the compartments 30, 8 of part A begins when the user initiates the cooking program sequence. Prior to rotation of the compartments, the cooking device 1 starts the heat source 3 to preheat the cooking surface of the vessel 2.

The temperature of the cooking surface is sensed by an infra-red sensor sensing temperature through the hollow stub 18 and receiver 19. When the cooking surface reaches a predetermined temperature for the user selected cooking program, the second part A is rotated by the driver 12 and liquid and/or solid ingredients are dispensed into the vessel 2.

Further rotations of the second part A with the compartments 30, 8 about the central void space of the first part B and relative to the base portion 10 with its segment void 34 allow further meal ingredients stored in the compartments 30, 8 to be dispensed. These further rotations occur at predetermined time intervals during the cooking program.

At conclusion of a cooking program, a warning sound or optical device like a light may sound or be illuminated indicating the program has terminated. The user can then remove the vessel 2 from the cooking device 1 by lifting the stub 18 out of the receiver 19. The user can then dispense cooked meal ingredients by manually manipulating the arm or blade 4 to help move ingredients to a top edge of vessel 2. The cooked meal can then be consumed.

### EXAMPLE 2

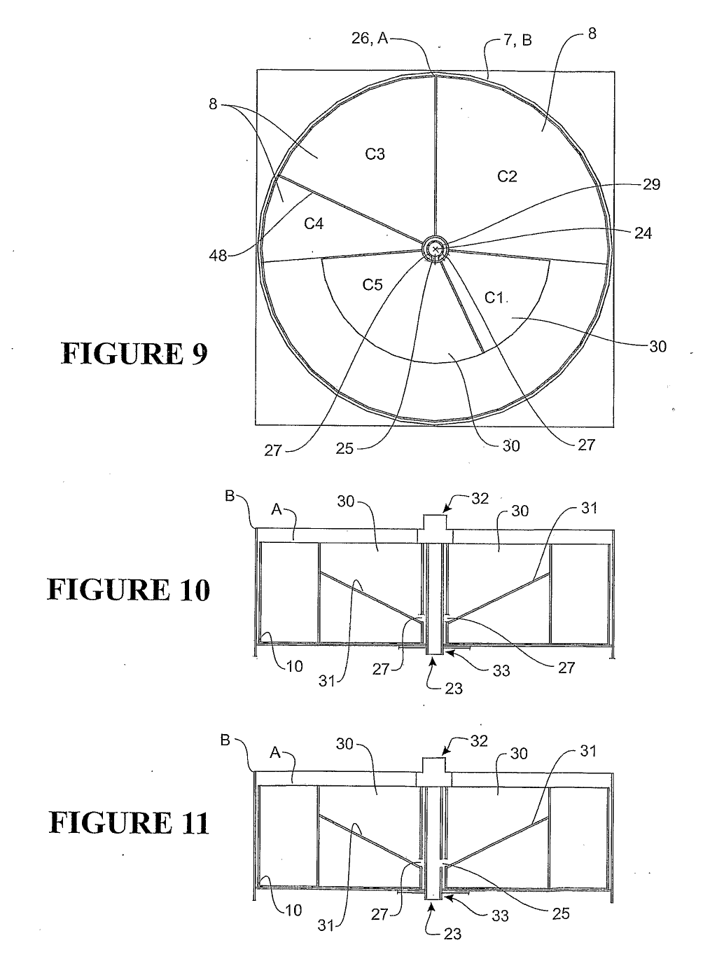

In another example, the operation as described above is repeated. However, a cartridge 6 as illustrated by FIGS. 9-11 is used. In such a cartridge 6, there is provided liquid ingredient compartments 30 and solid ingredient compartments 8. The chamber outward of the liquid food ingredients in this example is empty and is sealed, for example by a lid.

As shown by FIGS. 9 and 10, the cartridge 6 is to be inserted into the dispenser system 5 such that the openings 25, 27 for liquid ingredient compartments 30 are not aligned. Similarly, the solid ingredient compartments are not located over the segment void 34.

Once a cooking program is initiated, the compartments 8, 30 are moved into their first dispensing position. In this example, a first liquid compartment C1, for example containing oil, is rotated clock-wise until openings 25, 27 are aligned. Alignment of the openings 25, 27 allows oil to be drained out of the cartridge 6 via the central void 23 into an awaiting heated vessel 2.

Next, the compartments 8, 30 are rotated clock-wise again according to a predetermined time interval in the cooking program. Compartment C2 is moved into a position over the segment void 34 such that its solid ingredients, such as vegetables, fall from the compartment 8 into the vessel 2.

According to the cooking program and next time interval, the next compartments C3, containing for example meat, and C4, containing for example cashew, are likewise sequentially rotated so their contents fall into the vessel when positioned over the segment void 34. Finally, the cartridge 6 is rotated further so that compartment C6, containing for example a flavoursome sauce or condiment, is rotated so its opening 25 aligns with opening 27 and liquid ingredient drains into the vessel 2.

The cooking program then runs the remainder of its sequence of cooking ingredients until program completion. The meal is then cooked and ready for consumption.

### EXAMPLE 3

This example describes another embodiment of a cartridge and as shown by FIGS. 14 to 20.

Shown is a base portion 50 into which an insert in the form of a series of compartments 60 is engageable. In their engaged relationship, the base portion 50 houses the compartments 60.

The compartments 60 are shown empty, but in use would retain solid or liquid (or optionally a combination of both solid and liquid) meal ingredients. The compartments 60 and base portion 50 together define a receptacle to facilitate retaining of meal ingredients prior to dispensing into a cooking vessel during the course of a cooking program.

FIGS. 14 and 15, for example, illustrate a first aperture 40 in a first compartment 30, such a first compartment 30 utilised for retaining and dispensing of liquid ingredient. The first aperture 40 is illustrated at the base or floor of the compartment 30. FIG. 14 also illustrates a bowl-shaped configuration of this first liquid compartment 30 for directing or channelling of liquid ingredient to the first aperture 40.

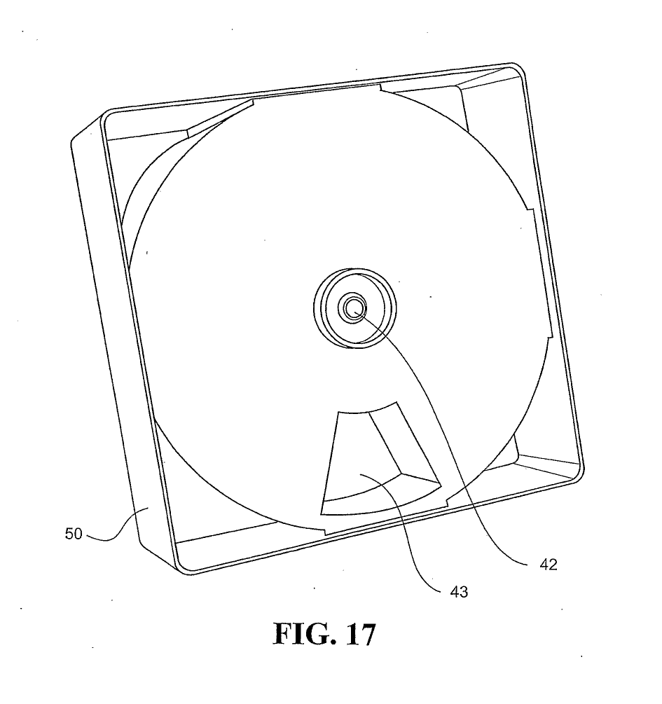

FIG. 15 shows the underside of the series of compartments 60 including the first aperture 40 which, when aligned with a second aperture 42 of the base portion 50 (shown in FIGS. 16, 17) provide for an outlet passage pathway for liquid ingredient otherwise retained in the first compartment 30. Non-alignment of first and second apertures 40, 42 ensures that, due to the interference fitment between base portion 50 and compartments 60, the outlet passage pathway is closed or blocked. Alignment of the apertures is enabled by movement of the compartments 60 relative to the base portion 50.

Also shown is second aperture 43 located in the base portion 50. FIGS. 16-18 illustrate this feature. Aperture 43 is an opening or void space in the base portion 50. Provision of such an opening or void space allows for contents of the compartments 60 to be dispensed when moved relative to the base portion 50 and the apertures 41 become communicable with such an opening or void space. Communication is provided by a first aperture 41 located at the base or floor of compartments 8 (i.e. the compartments are not provided with a floor or base, instead the base portion 50 provides for such a base or floor for supporting of ingredients located in such compartments). The ingredient contents are retained by the compartments 8 until an outlet passage from the compartment 8 is provided when the aperture 41 becomes aligned with the second aperture 43 or opening or void space. The compartments 8 with apertures 41 are preferentially used for retaining solid meal ingredients.

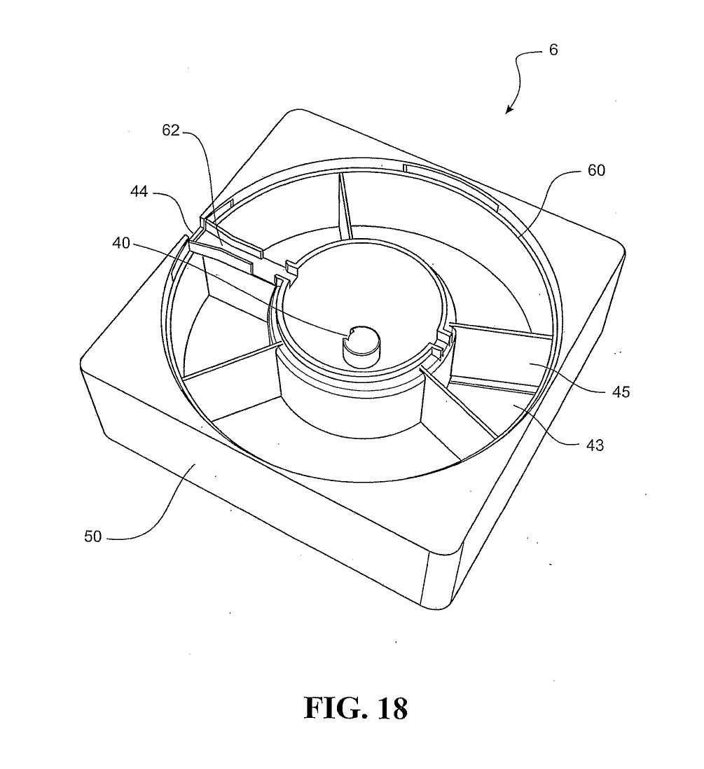

FIG. 18 shows an assembled cartridge 6 of a base portion 50 and compartments 60 in the form of a receptacle for meal ingredients (not shown in-situ). The assembled cartridge 6 is shown with a compartment labelled 45 in communication with the void space or second aperture 43 of the base portion. Such a configuration can be the initial sequence before an automated cooking program is activated, for example, the compartment 45 is left empty of ingredients so that as the compartments are rotated about the base portion the first compartment comprising ingredient for dispensing may be an adjacent compartment (depending on direction of compartment movement).

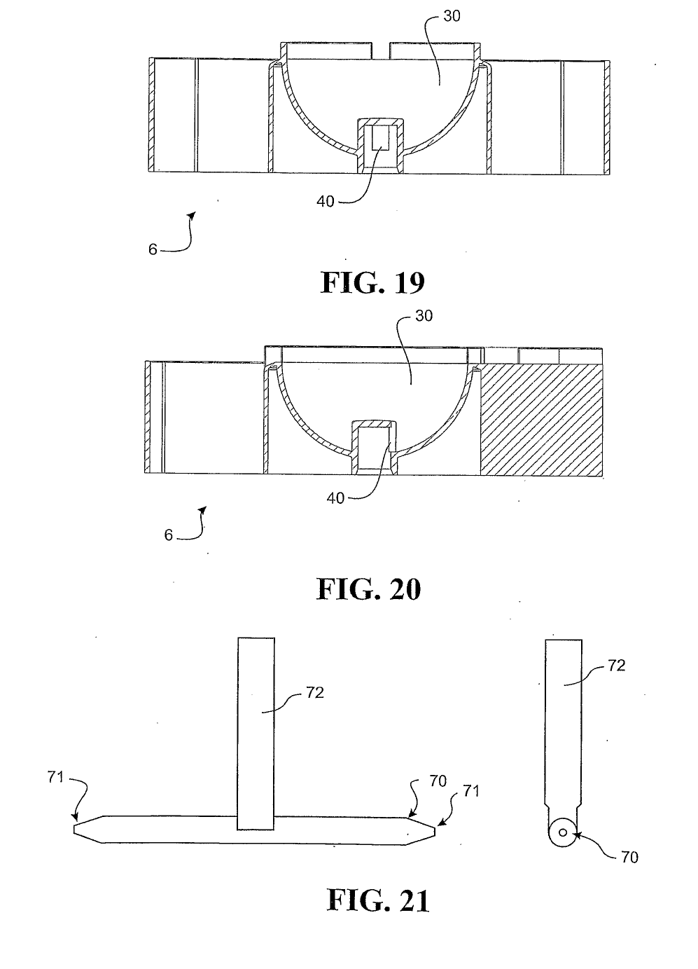

FIGS. 19 and 20 show a section view of the compartments with the first aperture 40 shown in a first position in FIG. 19 and then rotated through 90°, such as during a cooking program sequence, in FIG. 20

As most clearly shown by FIGS. 14 and 18, a connector arrangement is provided into which a driver or intermediate connection, such as a bar 70 connector (see FIG. 21) thereof is engageable for moving the compartments 60 relative to the base portion 50. Once the driver or an intermediate connection thereof is engaged in or with the connector arrangement, such as channel 62 with the compartments 60, the driver can operate in a controlled manner according to a cooking program for rotating of compartments about the base portion. In this manner, the compartments are moved about the base portion, their respective apertures coming into communication and releasing of ingredients retained in the compartments 30, 8. Where the connector is the bar 70, one or both of the ends 71 of the bar can be of a tapered form for ease of insertion into the channel 62 and engagement with the cartridge. Such a bar 70 has an extending shaft 72 which can be directly or indirectly driven by the driver. When activated, the driver can exert a rotation via shaft 72 on the bar 70 which is in turn imparted to the compartments of the cartridge, the compartments thereby being rotated about the base portion, rotation occurring at predetermined times during a cooking program.

The channel shown as 44 located on the base portion 50 is provided for ensuring the base portion 50 and compartments 60 are suitably aligned with each other when loading or inserting the cartridge 6 into the dispenser system 5 of a cooking device 1, the bar 70 for sliding engagement with the base portion's channel 44 prior to being seated in engagement with the compartment's connector arrangement or channel 62.

The foregoing description of the invention includes preferred forms thereof. Modifications may be made thereto without departing from the scope of the invention.

1-212. (canceled)

213. A pre-loadable cartridge for retaining and dispensing of ingredients of a meal or at least a part of a meal to be dispensed from the cartridge for subsequent combination with each other, the cartridge comprising:
an ingredient separating portion of at least two compartments, a first of said compartments to retain primarily solid ingredient and a second compartment to retain primarily liquid ingredient and
a base portion that together with the ingredient separating portion defines a receptacle for retaining said ingredients in each compartment,
the ingredient separating portion and base portion being moveable relative to each other,
wherein each compartment includes a first aperture, and the base portion includes at least one second aperture, such that in use, the ingredient separating portion is able to be moved relative to the base portion to allow the first aperture of each compartment to be moved into operable communication with at least one second aperture to provide an outlet passage for ingredient in each compartment from the cartridge through the base portion.

214. The pre-loadable cartridge as claimed in claim 213 wherein each first aperture and said at least one second aperture become communicable with each other by their alignment to define said outlet passage to dispense ingredients into an awaiting vessel at a preferred or predetermined time during a cooking program.

215. The pre-loadable cartridge as claimed in claim 213 wherein for each first aperture the base portion provides a respective second aperture so that liquid ingredient will pass through a first of said second apertures and solid ingredient will pass through a second of said second apertures.

216. The pre-loadable cartridge as claimed in claim 213, wherein the ingredient separating portion and base portion are separable.

217. The pre-loadable cartridge as claimed in claim 213 wherein the base portion and the ingredient separating portion are injection molded from a food grade polymeric material.

218. The pre-loadable cartridge as claimed in claim 213 wherein the base portion is sealingly engageable with the ingredient retaining portion in a manner to effect a sealing of the first aperture of each compartment to facilitate retaining of ingredient located therein.

219. The pre-loadable cartridge as claimed in claim 213, wherein
(a) the first aperture of the first compartment communicable with a second aperture of the base portion (hereinafter a “first base portion aperture”) providing for an outlet passage from the first compartment when in aligned communication, the first aperture of the first compartment and the first base potion aperture alignable by movement of the ingredient separating portion and base portion relative to one another and
(b) wherein the first aperture of the second compartment is communicable with a second aperture of the base portion (hereinafter a “second base portion aperture”) providing for an outlet passage from the second compartment when in aligned communication, the first aperture of the second compartment and the second base portion aperture alignable by movement of the ingredient separating portion and base portion relative to one another.

220. The pre-loadable cartridge as claimed in claim 213 wherein the base portion and the ingredient retaining portion are fittingly engageable with each other in a manner to form a seal between the base and the two compartments about their first aperture, when fitted together.

221. The pre-loadable cartridge as claimed in claim 220 wherein at least one of the base portion and ingredient retaining portion carries with it a layer provided to form said seal.

222. The pre-loadable cartridge as claimed in claim 221, wherein the layer is selected from at least one of (a) at least one o-ring and (b) at least one sleeve.

223. The pre-loadable cartridge as claimed in claim 213 wherein a said second aperture is a section of the base portion being a void space, such a void space defining an outlet passage to allow contents of at least one compartment to dispense therefrom when the first aperture is in communication, the apertures becoming communicable and non communicable by movement of the ingredient retaining portion relative to the base portion.

224. The pre-loadable cartridge as claimed in claim 213 wherein the outlet passage formed by communication of the second apertures allows for release of ingredient otherwise retained within a said compartment when the first aperture is not aligned with a said second aperture.

225. The pre-loadable cartridge as claimed in claim 213, wherein the ingredient retaining portion is moveable relative to the base portion according to a cooking program sequence, the cartridge having been loaded with ingredients before being subjected to said cooking program sequence.

226. A cooking device for cooking a meal or a part of a meal, the device comprising:
a receiver for a vessel including a cooking surface,
a heat source for heating of the cooking surface,
an arm or blade configured to move about the cooking surface for the moving of meal ingredients located thereon or within the vessel, and
a dispenser system in communication with the vessel, the dispenser system configured for receiving a cartridge as claimed in claim 213 containing liquid and solid meal ingredients to be dispensed from said cartridge into the vessel for cooking at preferred or predetermined times during a cooking program.

227. The device as claimed in claim 226 wherein the dispenser system is programmable or automated for dispensing of meal ingredients into the vessel according to a preferred or pre-determined cooking program.

228. The device as claimed in claim 226, wherein the dispenser system comprises a loading zone for receiving said pre loaded cartridge.

229. A cooking device for cooking a meal or a part of a meal, the device comprising:
a receiver for a cooking vessel, such a cooking vessel including a cooking surface,
a heat source for heating of the cooking surface,
an arm or blade configured to move about the cooking surface for the moving of meal ingredients located thereon or within the vessel, and
a dispenser system in communication with the vessel, the dispenser system configured for receiving a cartridge as claimed in claim 213 and containing meal ingredients to be dispensed into the vessel for cooking at preferred or predetermined times during a cooking program.

230. A cooking device for cooking a meal or a part of a meal, the device comprising:
a vessel including a cooking surface,
a heat source for heating of the cooking surface,
an arm or blade configured to move about the cooking surface for the moving of meal ingredients located thereon or within the vessel, and
a dispenser system in communication with the vessel, the dispenser system configured for receiving a cartridge as claimed in claim 213 and containing meal ingredients to be dispensed into the vessel for cooking at preferred or predetermined times during a cooking program.

231. A method for preparing a meal or a part of a meal, the method comprising:
selecting meal ingredients, the ingredients selected to form the or a part of a meal,
arranging or having the selected meal ingredients arranged in a cartridge as claimed in claim 213,
the cartridge being receivable by a dispensing system communicable with a cooking device,
the dispensing system programmable or automated for dispensing of the selected meal ingredients according to a preferred or pre-determined cooking program, the cooking program initiating or being initiated when the cooking device is operated or activated.

232. A method for preparing a meal or a part of a meal, the method comprising:
a consumer selecting from an available list of meal ingredients, the ingredients selected to form the or a part of a meal,
the consumer selected meal ingredients provided in an arranged manner in a cartridge as claimed in claim 213 the cartridge being compartmentalized, meal ingredients compartmentalized by food type or preferred cooking time or both,
placing the cartridge into a dispensing system communicable with a cooking device, the dispensing system programmable or automated for dispensing of meal ingredients according to a preferred or pre-determined cooking program, and
activating the cooking device to cook the meal ingredients according to the preferred or pre-determined cooking program.

233. A method for preparing a meal or a part of a meal, the method comprising:
a consumer selecting from an available list of meal options or part of a meal options comprising meal ingredients,
the meal options or the part of the meal options available are pre-arranged in a cartridge as claimed in claim 213
placing the cartridge into a dispensing system communicable with a cooking device, the dispensing system programmable or automated for dispensing of meal ingredients according to a preferred or pre-determined cooking program, and
activating the cooking device to cook the meal ingredients according to the preferred or pre-determined cooking program.

234. A pre-loaded cartridge for retaining and dispensing of pre-loaded ingredients of a meal or at least a part of a meal by a programmable device that can receive the cartridge and control the dispensing of said ingredients, the cartridge comprising a first part comprising two compartments that are partitioned from one another by at least one wall and
a second part of a base portion that together with the at least one compartment define a receptacle for retaining ingredients,
the first and second parts being engageable with one another and being moveable relative to each other,
wherein a first of said compartments includes at least a one first compartment aperture and the second part includes a second part aperture, such that in use, the first compartment aperture is able to become communicable with the second part aperture such communication providing for an outlet passage for ingredients in said first compartment, and
wherein a second of said compartments includes at least one second compartment aperture, such that in use, the second compartment aperture is able to become communicable with at least one of (i) the second part aperture and (ii) a second second part aperture, such communication providing for an outlet passage for ingredients in said second compartment, the apertures becoming communicable by virtue of movement of the first part relative to the second part.

235. A cartridge for retaining and dispensing of preloaded ingredients of a meal or at least a part of a meal, the cartridge comprising:
at least two compartments segregated from one another by dividers, and
a base portion to the compartments to, together, define two receptacles, and
wherein the compartments and the base portion are engageable with one another yet are moveable relative to each other to form a liquid-tight seal therebetween for at least one of said two receptacles.

236. The cartridge as claimed in claim 235 wherein at least one of the base portion and each said compartment carries with it a layer provided to form said seal.

237. A cooking device for cooking a meal or a part of a meal, the device comprising:
a receiver for a cooking vessel, such a cooking vessel including a cooking surface,
a heat source for heating of the cooking surface,
an arm or blade configured to move about the cooking surface for the moving of meal ingredients located thereon or within the vessel, and
a dispenser system in communication with the vessel, the dispenser system configured for receiving a cartridge as claimed in claim 235 and containing meal ingredients to be dispensed into the vessel for cooking at preferred or predetermined times during a cooking program.

238. A method for preparing a meal or a part of a meal, the method comprising:
a consumer selecting from an available list of meal ingredients, the ingredients selected to form the or a part of a meal,
the consumer selected meal ingredients provided in an arranged manner in a cartridge as claimed in claim 235 the cartridge being compartmentalized, meal ingredients compartmentalized by food type or preferred cooking time or both,
placing the cartridge into a dispensing system communicable with a cooking device, the dispensing system programmable or automated for dispensing of meal ingredients according to a preferred or pre-determined cooking program, and
activating the cooking device to cook the meal ingredients according to the preferred or pre-determined cooking program.
